(19) United States
(12) Patent Application Publication
(10) Pub. No.: US 2021/0103856 A1
(43) Pub. Date: Apr. 8, 2021

(54) SYSTEM AND METHOD TO PREDICT SUCCESS BASED ON ANALYSIS OF FAILURE

(71) Applicants: Northwestern University, Evanston, IL (US); The University of Chicago, Chicago, IL (US)

(72) Inventors: Dashun Wang, Evanston, IL (US); Yian Yin, Evanston, IL (US); Yang Wang, Xi'an (CN); James Evans, Chicago, IL (US)

(21) Appl. No.: 17/061,112

(22) Filed: Oct. 1, 2020

Related U.S. Application Data
(60) Provisional application No. 62/909,317, filed on Oct. 2, 2019.

(51) Int. Cl. G06N 20/00; G06N 5/02

(52) U.S. Cl. CPC G06N 20/00; G06N 5/02

(57) ABSTRACT

A system to predict success includes a memory configured to store failure data. The failure data includes information regarding one or more failed attempts to achieve a goal. The system also includes a processor operatively coupled to the memory. The processor is configured to analyze the failure data. The processor is also configured to determine, with an algorithm, a likelihood of success that the goal will be achieved on a subsequent attempt. The likelihood of success is based at least in part on the analysis of the failure data.

### CROSS-REFERENCE TO RELATED APPLICATION

The present application claims the priority benefit of U.S. Provisional Patent App. No. 62/909,317 filed on Oct. 2, 2019, the entire disclosure of which is incorporated by reference herein.

### GOVERNMENT LICENSE RIGHTS

This invention was made with government support under grant/award number FA9550-17-1-0089 awarded by the Air Force Office of Scientific Research (AFOSR), grant/award number FA9550-19-1-0354 awarded by the AFOSR, and grant/award number FA9550-15-1-0162 awarded by the AFOSR. The government has certain rights in the invention.

### BACKGROUND

Human achievements are often preceded by repeated attempts that fail. For example, a first researcher applying for a grant may fail to receive the grant after three initial attempts, but may finally receive the grant on his/her fourth attempt. A second researcher may similarly fail to receive a grant after three initial attempts, but may stop trying to receive the grant after his/her third attempt. This scenario represents two different eventual outcomes for two researchers who went down similar paths to obtain a grant. Numerous other scenarios of this type can be envisioned. To date, little is known about the mechanisms governing the dynamics of such failure scenarios.

### SUMMARY

An illustrative system to predict success includes a memory configured to store failure data. The failure data includes information regarding one or more failed attempts to achieve a goal. The system also includes a processor operatively coupled to the memory. The processor is configured to analyze the failure data. The processor is also configured to determine, with an algorithm, a likelihood of success that the goal will be achieved on a subsequent attempt. The likelihood of success is based at least in part on the analysis of the failure data.

An illustrative method for predicting success includes storing, on a memory of a computing system, failure data. The failure data includes information regarding one or more failed attempts to achieve a goal. The method also includes analyzing, by a processor operatively coupled to the memory, the failure data. The method further includes determining, by the processor and with an algorithm, a likelihood of success that the goal will be achieved on a subsequent attempt. The likelihood of success is based at least in part on the analyzing of the failure data.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1A depicts a chance model in accordance with an illustrative embodiment.

FIG. 1B depicts that the learning hypothesis predicts improved performance in accordance with an illustrative embodiment.

FIG. 1C depicts analysis of NIH grants with n=4872,5966 in accordance with an illustrative embodiment.

FIG. 1D depicts analysis of startups with n=579,548 in accordance with an illustrative embodiment.

FIG. 1E depicts analysis of terrorist attacks with n=231,230 in accordance with an illustrative embodiment.

FIG. 1F depicts that the failure streak length follows an exponential distribution for the chance model in accordance with an illustrative embodiment. The chance model thus predicts no performance change.

FIG. 1G depicts that the learning model has shorter failure streaks than expected by the chance model, corresponding to a faster-than-exponential distribution in accordance with an illustrative embodiment.

FIG. 1H depicts a failure streak based on analysis of the NIH grants in accordance with an illustrative embodiment.

FIG. 1I depicts a failure streak based on analysis of the startups in accordance with an illustrative embodiment.

FIG. 1J depicts a failure streak based on analysis of terrorist attacks in accordance with an illustrative embodiment.

FIG. 2A is a diagram depicts each attempt as a combination of many independent components (cm) in accordance with an illustrative embodiment.

FIG. 2B depicts formulation of a new attempt in accordance with an illustrative embodiment.

FIG. 2C depicts an analytical solution of the proposed k model in accordance with an illustrative embodiment.

FIG. 2D depicts simulation results from the proposed model (a =0.6) for a quality trajectory of a first k parameter in accordance with an illustrative embodiment.

FIG. 2E depicts simulation results from the proposed model (a =0.6) for a quality trajectory of a second k parameter in accordance with an illustrative embodiment.

FIG. 2F depicts simulation results from the proposed model (a =0.6) for a quality trajectory of a third k parameter in accordance with an illustrative embodiment.

FIG. 2G depicts simulation results from the proposed model for an efficiency trajectory for the first k parameter in accordance with an illustrative embodiment.

FIG. 2H depicts simulation results from the proposed model for an efficiency trajectory for the second k parameter in accordance with an illustrative embodiment.

FIG. 2I depicts simulation results from the proposed model for an efficiency trajectory for the third k parameter in accordance with an illustrative embodiment

FIG. 2J shows how the phase transition around k* predicts the coexistence of two groups that fall in the stagnation and progression regimes in accordance with a first illustrative embodiment.

FIG. 2K shows how the phase transition around k* predicts the coexistence of two groups that fall in the stagnation and progression regimes in accordance with a second illustrative embodiment.

FIG. 3A depicts a cumulative distribution function (CDF) of the number of consecutive failures prior to the last attempt for the success and non-success groups based on the NIH grant data in accordance with an illustrative embodiment.

FIG. 3B depicts a cumulative distribution function (CDF) of the number of consecutive failures prior to the last attempt for the success and non-success groups based on the startup data in accordance with an illustrative embodiment.

FIG. 3C depicts a cumulative distribution function (CDF) of the number of consecutive failures prior to the last attempt for the success and non-success groups based on the terrorist attack data in accordance with an illustrative embodiment.

FIG. 3D depicts how early temporal signals separate success and non-success groups based on the NIH grant data (n=43705,15132) in accordance with an illustrative embodiment.

FIG. 3E depicts how early temporal signals separate success and non-success groups based on the startup data (n=2455,16656) in accordance with an illustrative embodiment.

FIG. 3F depicts how early temporal signals separate success and non-success groups based on the terrorist attack data (n=446,321) in accordance with an illustrative embodiment.

FIG. 3G depicts how performance during a first attempt differs from performance of a second attempt for the NIH grant data in accordance with an illustrative embodiment.

FIG. 3H depicts how performance during a first attempt differs from performance of a second attempt for the startup data in accordance with an illustrative embodiment.

FIG. 3I depicts how performance during a first attempt differs from performance of a second attempt for the terrorist attack data in accordance with an illustrative embodiment.

FIG. 4A depicts simulation results from a k model with α=0.6 for k=0 in terms of average quality in accordance with an illustrative embodiment.

FIG. 4B depicts simulation results from a k model with α=0.6 for k→∞ in terms of average quality in accordance with an illustrative embodiment.

FIG. 4C depicts a comparison of k=0 and k→∞ in terms of average quality in accordance with an illustrative embodiment.

FIG. 4D depicts simulation results from a k model with α=0.6 for k=0 in terms of average efficiency in accordance with an illustrative embodiment.

FIG. 4E depicts simulation results from a k model with α=0.6 for k→∞ in terms of average efficiency in accordance with an illustrative embodiment.

FIG. 4F depicts a comparison of k=0 and k→∞ in terms of average efficiency in accordance with an illustrative embodiment.

FIG. 4G is a first depiction of mapping between failure dynamics in accordance with an illustrative embodiment.

FIG. 4H is a second depiction of mapping between failure dynamics in accordance with an illustrative embodiment.

FIG. 4I is a first depiction of mapping of canonical ensembles in accordance with an illustrative embodiment.

FIG. 4J is a second depiction of mapping of canonical ensembles in accordance with an illustrative embodiment.

FIG. 5A compares the goodness of fit for three different models (i.e., power law, exponential, and linear) in NIH grants in accordance with an illustrative embodiment.

FIG. 5B compares the goodness of fit for three different models (i.e., power law, exponential, and linear) in startups in accordance with an illustrative embodiment.

FIG. 5C compares the goodness of fit for three different models (i.e., power law, exponential, and linear) in terror attacks in accordance with an illustrative embodiment.

FIG. 5D depicts the goodness of fit for the three different models using |t_{N}31 \hat{t}_{N}| as the loss function for the NIH grant data in accordance with an illustrative embodiment.

FIG. 5E depicts the goodness of fit for the three different models using |t_{N}31 \hat{t}_{N}| as the loss function for the startup data in accordance with an illustrative embodiment.

FIG. 5F depicts the goodness of fit for the three different models using |t_{N}−\hat{t}_{N}| as the loss function for the terror attack data in accordance with an illustrative embodiment.

FIG. 6A depicts Area Under the curve of the Receiver Operating Characteristic (AUROC) of the prediction task for the NIH grant data in accordance with an illustrative embodiment.

FIG. 6B depicts AUROC of the prediction task for the startup data in accordance with an illustrative embodiment.

FIG. 6C depicts AUROC of the prediction task for the terror attack data in accordance with an illustrative embodiment.

FIG. 6D shows prediction of ultimate success in NIH grantes for male investigators in accordance with an illustrative embodiment.

FIG. 6E shows prediction of ultimate success in NIH grantes for female investigators in accordance with an illustrative embodiment.

FIG. 7A is a first illustration depicting component dynamics in accordance with an illustrative embodiment.

FIG. 7B is a second illustration depicting component dynamics in accordance with an illustrative embodiment.

FIG. 7C depicts length of failure streak after randomization for the NIH grant data in accordance with an illustrative embodiment.

FIG. 7D depicts length of failure streak after randomization for the startup data in accordance with an illustrative embodiment.

FIG. 7E depicts length of failure streak after randomization for the terror attack data in accordance with an illustrative embodiment.

FIG. 7F depicts temporal scaling patterns within the success group for the NIH grant data in accordance with an illustrative embodiment.

FIG. 7G depicts temporal scaling patterns within the success group for the startup data in accordance with an illustrative embodiment.

FIG. 7H depicts temporal scaling patterns within the success group for the terror attack data in accordance with an illustrative embodiment.

FIG. 8A depicts robustness of the model in terms of number of failures for the NIH grant data with a 3 year threshold of inactivity in accordance with an illustrative embodiment.

FIG. 8B depicts robustness of the model in terms of number of failures for the startup data with a 3 year threshold of inactivity in accordance with an illustrative embodiment.

FIG. 8C depicts robustness of the model in terms of number of failures for the terror attack data with a 3 year threshold of inactivity in accordance with an illustrative embodiment.

FIG. 8D depicts temporal scaling patterns for the NIH grant data in accordance with an illustrative embodiment.

FIG. 8E depicts temporal scaling patterns for the startup data in accordance with an illustrative embodiment.

FIG. 8F depicts temporal scaling patterns for the terror attack data in accordance with an illustrative embodiment.

FIG. 8G depicts performance dynamics for the NIH grant data in accordance with an illustrative embodiment.

FIG. 8H depicts performance dynamics for the startup data in accordance with an illustrative embodiment.

FIG. 8I depicts performance dynamics for the terror attack data in accordance with an illustrative embodiment.

FIG. 8J depicts an AUROC score of predicting ultimate success in the NIH grant data in accordance with an illustrative embodiment.

FIG. 8K depicts an AUROC score of predicting ultimate success in the startup data in accordance with an illustrative embodiment.

FIG. 8L depicts an AUROC score of predicting ultimate success in the terror attack data in accordance with an illustrative embodiment.

FIG. 8M depicts robustness of the model in terms of number of failures for the NIH grant data with a 7 year threshold of inactivity in accordance with an illustrative embodiment.

FIG. 8N depicts robustness of the model in terms of number of failures for the startup data with a 7 year threshold of inactivity in accordance with an illustrative embodiment.

FIG. 8O depicts robustness of the model in terms of number of failures for the terror attack data with a 7 year threshold of inactivity in accordance with an illustrative embodiment.

FIG. 8P depicts temporal scaling patterns for the NIH grant data (7 year threshold of inactivity) in accordance with an illustrative embodiment.

FIG. 8Q depicts temporal scaling patterns for the startup data (7 year threshold of inactivity) in accordance with an illustrative embodiment.

FIG. 8R depicts temporal scaling patterns for the terror attack data (7 year threshold of inactivity) in accordance with an illustrative embodiment.

FIG. 8S depicts performance dynamics for the NIH grant data (7 year threshold of inactivity) in accordance with an illustrative embodiment.

FIG. 8T depicts performance dynamics for the startup data (7 year threshold of inactivity) in accordance with an illustrative embodiment.

FIG. 8U depicts performance dynamics for the terror attack data (7 year threshold of inactivity) in accordance with an illustrative embodiment.

FIG. 8V depicts an AUROC score of predicting ultimate success in the NIH grant data (7 year threshold of inactivity) in accordance with an illustrative embodiment.

FIG. 8W depicts an AUROC score of predicting ultimate success in the startup data (7 year threshold of inactivity) in accordance with an illustrative embodiment.

FIG. 8X depicts an AUROC score of predicting ultimate success in the terror attack data (7 year threshold of inactivity) in accordance with an illustrative embodiment.

FIG. 9A depicts the failure streak with a score threshold of 55 in accordance with an illustrative embodiment.

FIG. 9B depicts the failure streak excluding revisions as successes in accordance with an illustrative embodiment.

FIG. 9C depicts the failure streak for new PIs without previous grants in accordance with an illustrative embodiment.

FIG. 9D depicts the temporal scaling pattern for a score threshold of 55 in accordance with an illustrative embodiment.

FIG. 9E depicts the temporal scaling pattern excluding revisions as successes in accordance with an illustrative embodiment.

FIG. 9F depicts the temporal scaling pattern for new PIs without previous grants in accordance with an illustrative embodiment.

FIG. 9G depicts performance dynamics with a score threshold of 55 in accordance with an illustrative embodiment.

FIG. 9H depicts performance dynamics excluding revisions as successes in accordance with an illustrative embodiment.

FIG. 9I depicts performance dynamics for new PIs without previous grants in accordance with an illustrative embodiment.

FIG. 9J depicts the AUROC score of predicting ultimate success with a score threshold of 55 in accordance with an illustrative embodiment.

FIG. 9K depicts the AUROC score of predicting ultimate success with exclusion of revisions as successes in accordance with an illustrative embodiment.

FIG. 9L depicts the AUROC score of predicting ultimate success for new PIs without prior grants in accordance with an illustrative embodiment.

FIG. 10A depicts the failure streak with a threshold of high-value M&A set at 5% in accordance with an illustrative embodiment.

FIG. 10B depicts the failure streak excluding M&As as successes in accordance with an illustrative embodiment.

FIG. 10C depicts the failure streak with unicorns classified as successes in accordance with an illustrative embodiment.

FIG. 10D depicts the temporal scaling pattern with a threshold of high-value M&A set at 5% in accordance with an illustrative embodiment.

FIG. 10E depicts the temporal scaling pattern excluding M&As as successes in accordance with an illustrative embodiment.

FIG. 10F depicts the temporal scaling pattern with unicorns classified as successes in accordance with an illustrative embodiment.

FIG. 10G depicts performance dynamics with a threshold of high-value M&A set at 5% in accordance with an illustrative embodiment.

FIG. 10H depicts performance dynamics excluding M&As as successes in accordance with an illustrative embodiment.

FIG. 10I depicts performance dynamics with unicorns classified as successes in accordance with an illustrative embodiment.

FIG. 10J depicts the AUROC score of predicting ultimate success with a threshold of high-value M&A set at 5% in accordance with an illustrative embodiment.

FIG. 10K depicts the AUROC score of predicting ultimate success excluding M&As as successes in accordance with an illustrative embodiment.

FIG. 10L depicts the AUROC score of predicting ultimate success with unicorns classified as successes in accordance with an illustrative embodiment.

FIG. 11A depicts the failure streak over all samples in accordance with an illustrative embodiment.

FIG. 11B depicts the failure streak over samples of human-targeted attacks in accordance with an illustrative embodiment.

FIG. 11C depicts the failure streak for samples that include vague data on fatality in accordance with an illustrative embodiment.

FIG. 11D depicts the temporal scaling pattern over all samples in accordance with an illustrative embodiment.

FIG. 11E depicts the temporal scaling pattern over samples of human-targeted attacks in accordance with an illustrative embodiment.

FIG. 11F depicts the temporal scaling pattern over samples that include vague data on fatality in accordance with an illustrative embodiment.

FIG. 11G depicts performance dynamics over all samples in accordance with an illustrative embodiment.

FIG. 11H depicts performance dynamics over samples of human-targeted attacks in accordance with an illustrative embodiment.

FIG. 11I depicts performance dynamics over samples that include vague data on fatality in accordance with an illustrative embodiment.

FIG. 11J depicts the AUROC score of predicting ultimate success over all samples in accordance with an illustrative embodiment.

FIG. 11K depicts the AUROC score of predicting ultimate success over samples of human-targeted attacks in accordance with an illustrative embodiment.

FIG. 11L depicts the AUROC score of predicting ultimate success over samples that include vague data on fatality in accordance with an illustrative embodiment. The centers and error bars of AUROC scores denote the mean and s.e.m calculated from 10-fold cross validation over 50 randomized iterations.

FIG. 11M depicts the temporal scalling pattern for a threshold of fatal attacks that killed at least 5 people in accordance with an illustrative embodiment.

FIG. 11N depicts the temporal scalling pattern for a threshold of fatal attacks that killed at least 10 people in accordance with an illustrative embodiment.

FIG. 11O depicts the temporal scalling pattern for a threshold of fatal attacks that killed at least 100 people in accordance with an illustrative embodiment.

FIG. 12A depicts a failure streak for the NIH grant data, while controlling for temporal variation, in accordance with an illustrative embodiment.

FIG. 12B depicts a failure streak for the startup data, while controlling for temporal variation, in accordance with an illustrative embodiment.

FIG. 12C depicts a failure streak for the terror attack data, while controlling for temporal variation, in accordance with an illustrative embodiment.

FIG. 12D depicts the temportal scaling pattern for the NIH grant data, while controlling for temporal variation, in accordance with an illustrative embodiment.

FIG. 12E depicts the temportal scaling pattern for the startup data, while controlling for temporal variation, in accordance with an illustrative embodiment.

FIG. 12F depicts the temportal scaling pattern for the terror attack data, while controlling for temporal variation, in accordance with an illustrative embodiment.

FIG. 12G depicts performance dynamics for the NIH grant data, while controlling for temporal variation, in accordance with an illustrative embodiment.

FIG. 12H depicts performance dynamics for the startup data, while controlling for temporal variation, in accordance with an illustrative embodiment.

FIG. 12I depicts performance dynamics for the terror attack data, while controlling for temporal variation, in accordance with an illustrative embodiment.

FIG. 12J depicts performance dynamics based on a comparison of the first and halfway attempts for the NIH grant data in accordance with an illustrative embodiment.

FIG. 12K depicts performance dynamics based on a comparison of the first and halfway attempts for the startup data in accordance with an illustrative embodiment.

FIG. 12L depicts performance dynamics based on a comparison of the first and halfway attempts for the terror attack data in accordance with an illustrative embodiment.

FIG. 12M depicts performance dynamics based on a comparison of the first and penultimate attempts for the NIH grant data in accordance with an illustrative embodiment.

FIG. 12N depicts performance dynamics based on a comparison of the first and penultimate attempts for the startup data in accordance with an illustrative embodiment.

FIG. 12O depicts performance dynamics based on a comparison of the first and penultimate attempts for the terror attack data in accordance with an illustrative embodiment.

FIG. 12P depicts the correlation between length of failure streak and initial performance for samples with repeated failures in the NIH grant data in accordance with an illustrative embodiment.

FIG. 12Q depicts the correlation between length of failure streak and initial performance for samples with repeated failures in the startup data in accordance with an illustrative embodiment.

FIG. 12R depicts the correlation between length of failure streak and initial performance for samples with repeated failures in the terror attack data in accordance with an illustrative embodiment.

FIG. 12S depicts a length of failure streak that still follows fat-tailed distributions conditional on the bottom 10% of initial performance samples in the NIH grant data in accordance with an illustrative embodiment.

FIG. 12T depicts a length of failure streak that still follows fat-tailed distributions conditional on the bottom 10% of initial performance samples in the startup data in accordance with an illustrative embodiment.

FIG. 12U depicts a length of failure streak that still follows fat-tailed distributions conditional on the bottom 10% of initial performance samples in the terror attack data in accordance with an illustrative embodiment.

FIG. 13A depicts how the a parameter connects the potential to improve 1−x and likelihood to create new versions p through p=(1−x)^{α} in accordance with an illustrative embodiment.

FIG. 13B depicts a phase diagram of the k−α model in accordance with an illustrative embodiment.

FIG. 13C depicts the impact of δ parameter on scaling exponent γ for given of k=1,2,3 and α=0.4, 0.8, 1.2 in accordance with an illustrative embodiment.

FIG. 13D depicts a phase diagram of the k−α−δ model for k=3, with boundaries at α=δ, (k−1)δ=1, kα=1, and (k−1)α=1, respectively, in accordance with an illustrative embodiment.

FIG. 14 is a block diagram of a computing system for a success prediction system in accordance with an illustrative embodiment.

### DETAILED DESCRIPTION

Described herein is a straightforward one-parameter model that mimics how successful future attempts build on past attempts and failures. Analytically solving this model suggests a phase transition that separates dynamics of failure into regions of progression or stagnation, predicting that near a critical threshold, agents who share similar characteristics and learning strategies may experience fundamentally different outcomes following failures. Above the critical threshold, those who exploit incremental refinements systematically advance toward success. However, agents below the critical threshold tend to explore disjoint opportunities without a pattern of improvement. The model makes several empirically testable predictions, demonstrating that those who eventually succeed and those who do not may initially appear similar, yet can be characterized by fundamentally distinct failure dynamics in terms of the efficiency and quality associated with each subsequent attempt.

The proposed model was tested via collection of large-scale data from three disparate domains, tracing repeated attempts by (i) National Institutes of Health (NIH) investigators to fund their research, (ii) innovators to successfully exit their startup ventures, and (iii) terrorist organizations to post casualties in violent attacks. In alternative implementations, different domains may be used. The proposed model shows broadly consistent empirical support across all three domains, which systematically verifies each prediction of the model. Together, the findings demonstrate identifiable yet previously unknown early signals that allow one to identify failure dynamics that will lead to ultimate success or failure. Given the ubiquitous nature of failure and the paucity of quantitative approaches to understand it, these results represent an initial but crucial step toward deeper understanding of the complex dynamics beneath failure, which can be seen as an essential prerequisite for success.

The first large-scale dataset (D₁) contains all R01 grant applications ever submitted to the National Institutes of Health (776,721 applications by 139,091 investigators, submitted between 1985-2015). For each grant application, ground-truth information was obtained on whether or not it was funded, allowing reconstruction of individual application histories and their repeated attempts to obtain funding. The second dataset (D₂) traces start-up investment records from VentureXpert (58,111 startup companies involving 253,579 innovators, with records from 1970-2016). Tracing every startup in which venture capitalists (VCs) invested, D₂ allows for reconstruction of individual career histories counting successive ventures in which they were involved. Successful ventures were classified as those that achieved an initial public offering (IPO) or high value merger and acquisition (M&A), and correspondingly failed attempts are classified as those that failed to obtain such an exit within five years after their first VC investment. Going beyond traditional innovation domains, the third dataset (D₃) is from the Global Terrorism Database (170,350 terrorist attacks by 3,178 terrorist organizations, with data from 1970-2017). For each organization, their attack histories were tracked and classified as successful for fatal attacks that killed at least one person. Attacks that failed to claim casualties were classified as a failure.

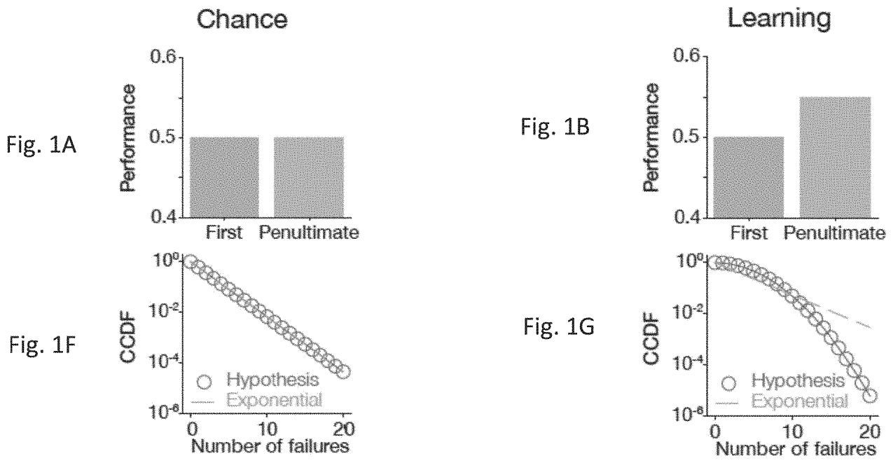

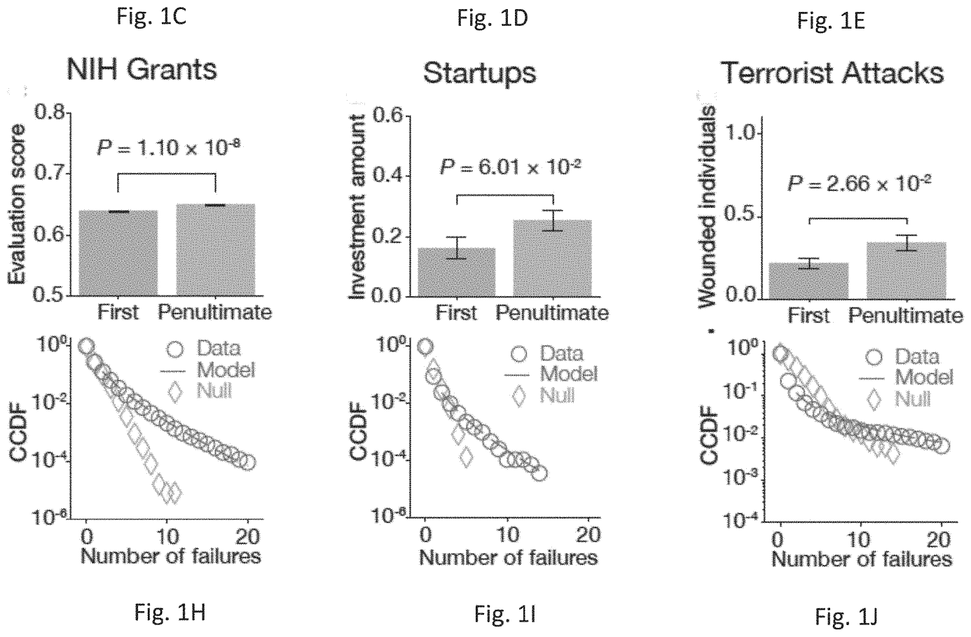

Chance and learning are two primary mechanisms explaining how failures may lead to success. If each attempt has a certain likelihood of success, the probability that multiple attempts all lead to failure decreases exponentially with each trial. The chance model therefore emphasizes the role of luck, suggesting that success eventually arises from an accumulation of independent trials. To test this, the performance of the first and penultimate attempt were compared within failure streaks, measured by NIH percentile score for a grant application (D₁), investment size by VCs to a company (D₂), and number of wounded individuals by an attack (D₃). It was found that across all three datasets, the penultimate attempt shows systematically better performance than the initial attempt, as shown in FIGS. 1C-1E.

The results of the analyses reject the notion that success is simply driven by chance (FIG. 1A), and lend support to the learning mechanism (FIG. 1B), which suggests that failure may teach valuable lessons difficult to learn otherwise. As such, learning reduces the number of failures required to achieve success, and predicts that failure streaks should follow a narrower length distribution (FIG. 1G) than the exponential one predicted by chance (FIG. 1F). Yet in contrast, across all three domains, failure streak length follows a fat-tailed distribution (FIGS. 1H-1J), indicating that despite performance improvement, failures are characterized by longer-than-expected streaks prior to the onset of success. Together, these observations demonstrate that neither chance nor learning alone can explain the empirical patterns underlying failures, suggesting that more complex dynamics are at work.

FIG. 1 depicts the mechanisms of chance and learning. Specifically, FIGS. 1A-1E compare theoretical predictions and empirical measurements for performance changes, and FIGS. 1F-1J depict the length distribution of failure streaks. FIG. 1A depicts a chance model in accordance with an illustrative embodiment. FIG. 1F depicts that the failure streak length follows an exponential distribution for the chance model in accordance with an illustrative embodiment. The chance model thus predicts no performance change. FIG. 1B depicts that the learning hypothesis predicts improved performance in accordance with an illustrative embodiment. FIG. 1G depicts that the learning model has shorter failure streaks than expected by the chance model, corresponding to a faster-than-exponential distribution in accordance with an illustrative embodiment.

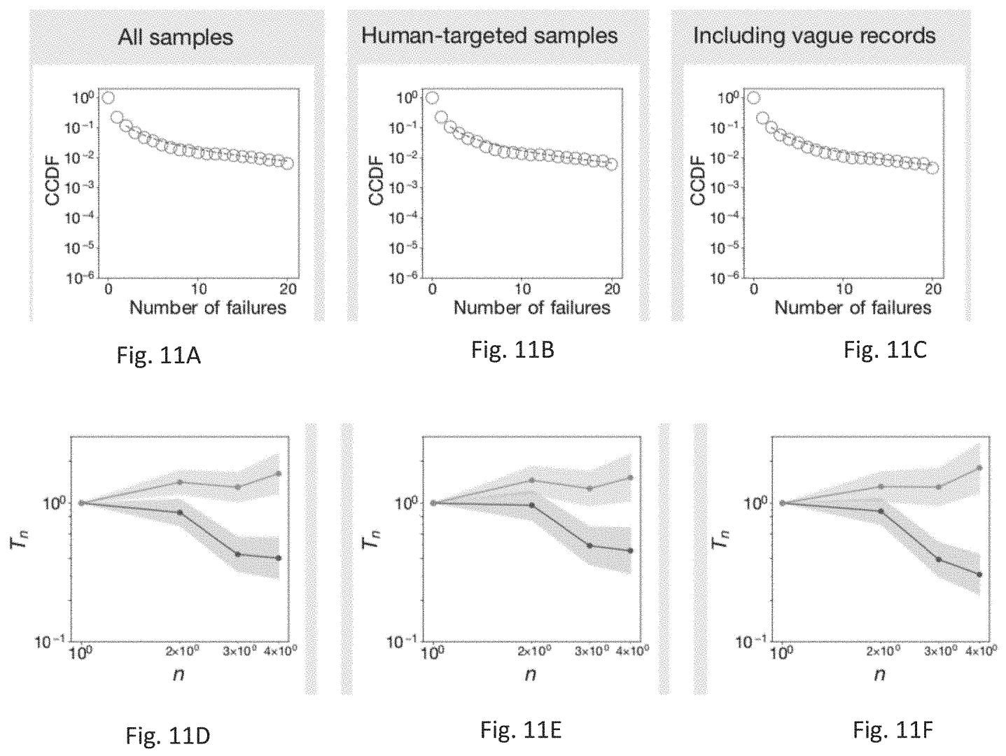

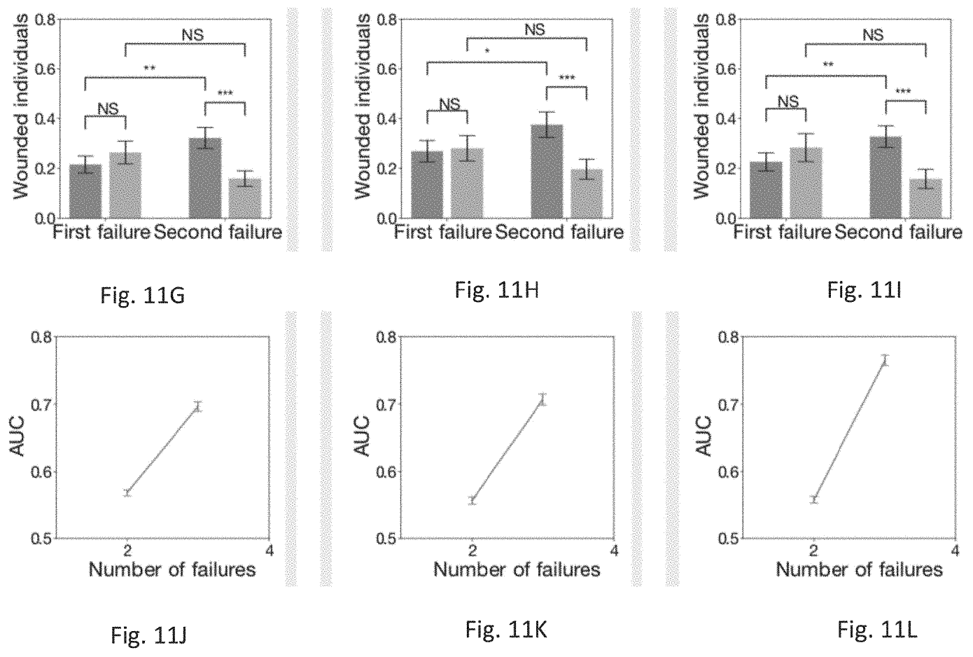

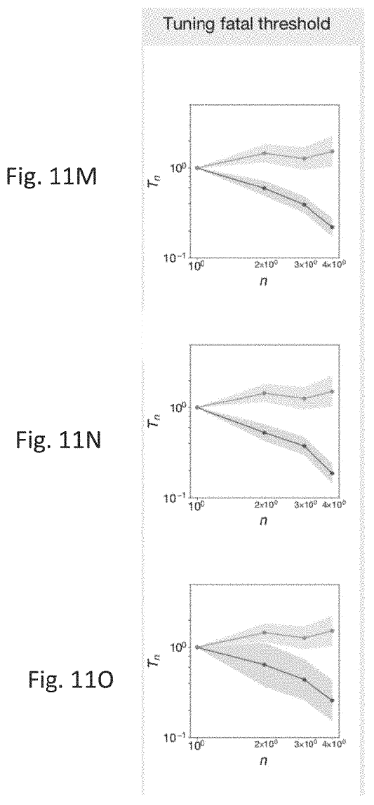

Both the chance and learning hypotheses are contested by empirical patterns observed across the three datasets. To ensure that performance metrics are comparable across data and models, performance measures were standardized according to their underlying distribution. It was found that failures in real data are associated with improved performance between the first and penultimate attempt (two-sided t-test). FIG. 1C depicts analysis of NIH grants with n=4872,5966 in accordance with an illustrative embodiment. FIG. 1D depicts analysis of startups with n=579,548 in accordance with an illustrative embodiment. FIG. 1E depicts analysis of terrorist attacks with n=231,230 in accordance with an illustrative embodiment. In FIGS. 1C-1E, the center and error bar show the mean and standard error of the mean. However, at the same time, failure streaks are characterized by a fat-tailed length distribution, indicating that failure streaks in real data are longer than expected by chance, as shown in FIGS. 1H-1J. FIG. 1H depicts a failure streak based on analysis of the NIH grants in accordance with an illustrative embodiment. FIG. 11 depicts a failure streak based on analysis of the startups in accordance with an illustrative embodiment. FIG. 1J depicts a failure streak based on analysis of terrorist attacks in accordance with an illustrative embodiment. For clarity, results are shown for failure streaks whose length is less than 21. A randomized sequence of successes and failures was also constructed by assigning each attempt to agents at random. It was found that failure streak length in a randomized sequence follows an exponential like distribution, showing clear deviations from data.

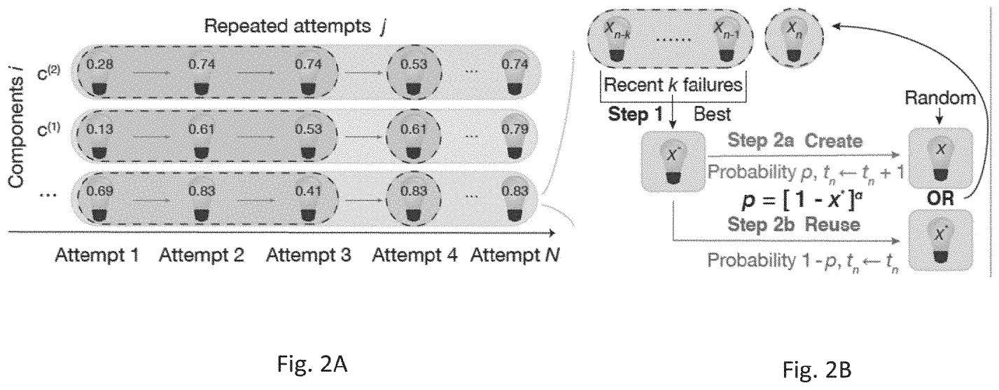

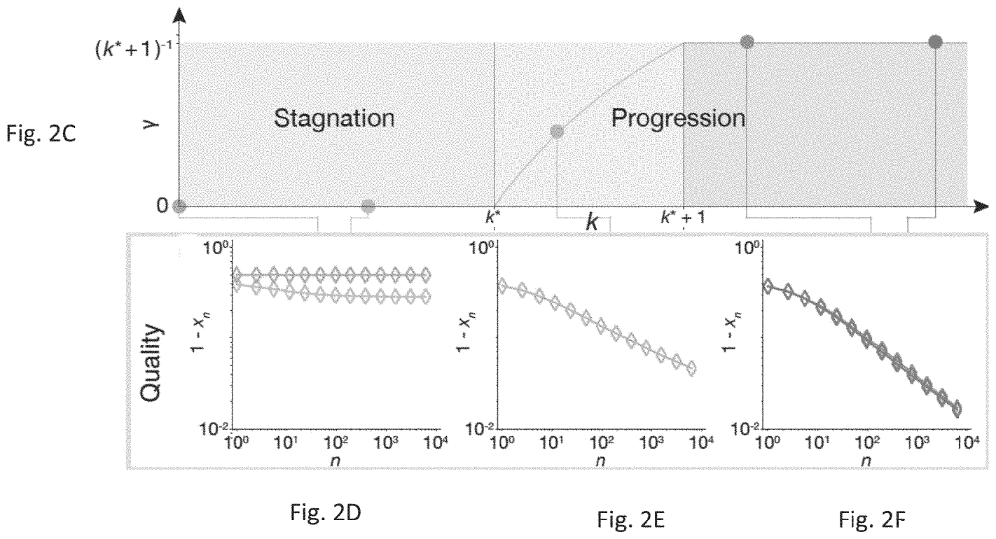

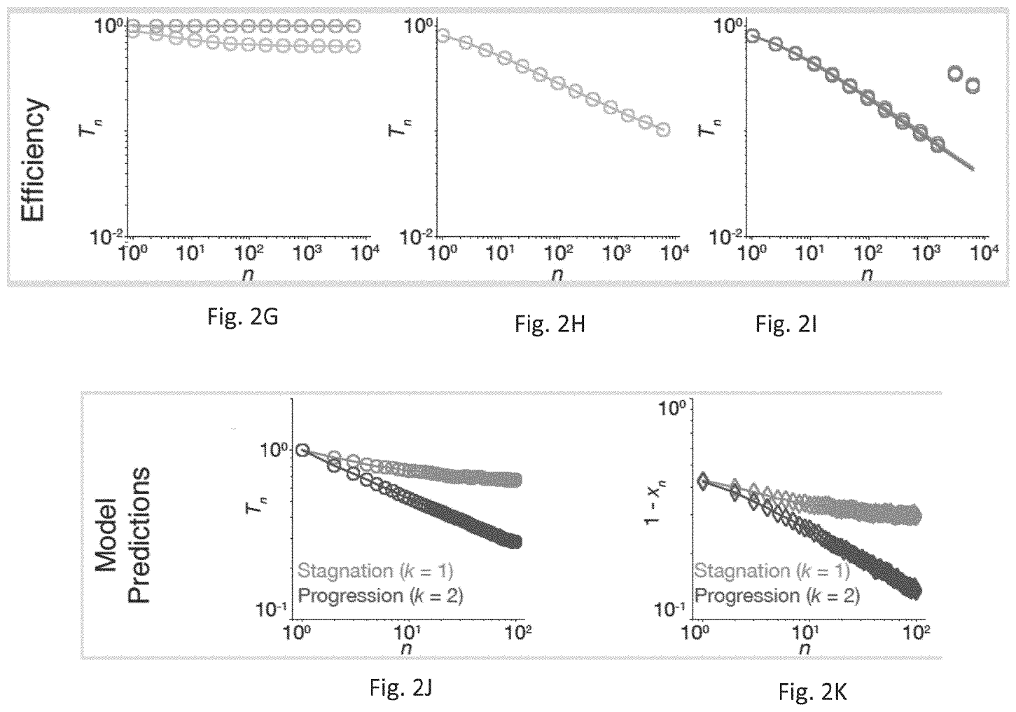

The aforementioned interplay between chance and learning was further explored by developing a simple one-parameter model that mimics how future attempts build on previous failures. Each attempt was considered to include many independent, unweighted components, with each component i being characterized by an evaluation score x(ⁱ) (FIG. 2A). Using the submission of an NIH proposal as an example, components include constructing a bio-sketch, assembling a budget, writing a data management plan, adding preliminary data, outlining broader impacts, etc. It is also noted that granting agencies often provide rubrics for grading proposals on specific components.

To formulate a new attempt, one goes through each component, and decides to either (1) create a new version (with probability p), or (2) reuse the best version x* among the previous k attempts (with probability 1−p) (FIG. 2B). A new version is assigned a score drawn randomly from a uniform distribution U[0,1], approximating the percentile of score distributions that real systems follow. The decision to create a new version is often not random, but driven by the quality of prior versions. Indeed, given the best version x*, 1−x captures the potential to improve it. The higher this potential, the more likely one may create a new version, prompting consideration of a simple relationship, p=(1−x*)^{α, with α>}0. Creating a new version takes one unit of time with no certainty that its score will be higher or lower than the previous one. By contrast, reusing the best version from the past saves time, and allows the component to retain its best score x*.

A single parameter k was explored for the proposed model, measuring the number of previous attempts one considers when formulating a new one (FIG. 2B). Mathematically, the dynamical process can be described as xₙ˜pU [0,1]+(1−p)δ(x−x*ₙ), where x*ₙ=max{xₙ₋ₖ, . . . , xₙ₋₁}. The dynamics of the model are quantified by calculating (i) the quality of the n-th attempt, <xₙ>, which measures the average score of all components, and (ii) the efficiency after that attempt, <tₙ>, which captures the expected proportion of components updated in new versions. The two extreme cases can be considered as follows. A result of k=0 means each attempt is independent from those past. Here the proposed model recovers the chance model, predicting that as n increases, both <xₙ> and <tₙ> remain constant. That is, without considering past experience, failure does not lead to quality improvement. Nor is it more efficient to try again. The other extreme (k→∞) considers all past attempts. The model predicts a temporal scaling in failure dynamics. That is, the time it takes to formulate a new attempt decays with n, asymptotically following a power law:

Tₙ≡<tₙ>/<t₁>˜n^{-γ}, Eq. 1:

where γ=γ_{∞}=α/(α+1) falls between 0 and 1. Besides increased efficiency, new attempts also improve in quality, as the average potential for improvement decays following <1−xₙ>˜n^{-η∞}, where η_{∞}=min{γ_{∞}, 1−γ_{∞}}. Here the model recovers the canonical result from the learning literature, commonly known as Wright's Law. This is because, as experience accumulates, high-quality versions are preferentially retained, while their lower quality counterparts are more likely to receive updates. As fresh attempts improve in quality, they reduce the need to start anew, thus increasing the efficiency of future attempts.

These two limiting cases might lead one to suspect a gradual emergence of scaling behavior as people learn from more failures. On the contrary, as parameter k is increased, the scaling exponent γ follows a discontinuous pattern (FIG. 2C) and only varies within a narrow interval of └k┘<k<┌k*┐+1(k*≡1/α). Indeed, when k is small (k<k*), the system converges back to the same asymptotic behavior as k=0 (FIGS. 2C, 2D, 2G). In this region, k is not large enough to retain a good version once it appears. As a result, while performance might improve slightly in the first few attempts, it quickly saturates. In this region, agents reject prior attempts and thrash around for new versions, not processing enough feedback to initiate a pattern of intelligent improvement, prompting it to be called the stagnation region. Once k passes the critical threshold k*, however, scaling behavior emerges (FIGS. 2C, 2E, 2H), indicating that the system enters a region of progression, where failures lead to continuous improvement in both quality and efficiency. Nevertheless, with a single additional experience considered, the system quickly hits the second critical point k*+1, beyond which the scaling exponent y becomes independent of k (FIGS. 2C, 2F, 2I). This means that once ┌k*┐+1 number of prior failures are considered, the system is characterized by the same dynamical behavior as k→∞, indicating that ┌k*┐+1 attempts are sufficient to recover the same rate of improvement as considering every failure from the past.

FIG. 2 depicts use of the proposed k model. FIG. 2A is a diagram that depicts each attempt as a combination of many independent components (c⁽ⁱ⁾) in accordance with an illustrative embodiment. For an attempt j, each component i is characterized by an evaluation score xⱼ⁽ⁱ⁾, which falls between 0 and 1. The score for a new version is often unknown until attempted, hence a new version is assigned a score, drawn randomly from [0,1]. FIG. 2B depicts formulation of a new attempt in accordance with an illustrative embodiment. To formulate a new attempt, one can either create a new version (with probability p, green arrow), or reuse an existing version by choosing the best one among past versions x* (with probability 1−p, red arrow). Indeed, P(x≥x*)=1−x* captures the potential to improve on prior versions, prompting one to assume p=(1−x*)^{α}, where α>0 characterizes an agent's propensity to create new versions given the quality of existing ones. FIG. 2C depicts an analytical solution of the proposed k model in accordance with an illustrative embodiment. The analytical solution of the model reveals that the system is separated into three regimes by two critical points k* and k*+1. The solid line shows an extended solution space of the analytical results.

FIG. 2D depicts simulation results from the proposed model (α=0.6) for a quality trajectory of a first k parameter in accordance with an illustrative embodiment. FIG. 2E depicts simulation results from the proposed model (α=0.6) for a quality trajectory of a second k parameter in accordance with an illustrative embodiment. FIG. 2F depicts simulation results from the proposed model (α=0.6) for a quality trajectory of a third k parameter in accordance with an illustrative embodiment. FIG. 2G depicts simulation results from the proposed model for an efficiency trajectory for the first k parameter in accordance with an illustrative embodiment. FIG. 2H depicts simulation results from the proposed model for an efficiency trajectory for the second k parameter in accordance with an illustrative embodiment. FIG. 2I depicts simulation results from the proposed model for an efficiency trajectory for the third k parameter in accordance with an illustrative embodiment. Thus, FIGS. 2D-2I show distinct dynamical behavior in different regimes. All results are based on simulations averaged over 10⁴ times. FIG. 2J shows how the phase transition around k* predicts the coexistence of two groups that fall in the stagnation and progression regimes in accordance with a first illustrative embodiment. FIG. 2K shows how the phase transition around k* predicts the coexistence of two groups that fall in the stagnation and progression regimes in accordance with a second illustrative embodiment.

Importantly, the two critical points in the proposed model can be mapped to phase transitions within a canonical ensemble that includes three energy levels. Phase transitions indicate that small variations at the microscopic level may lead to fundamentally different macroscopic behaviors. For example, two individuals near the critical point may initially appear identical in their learning strategy or other characteristics, yet depending on which region they inhabit, their outcomes following failures could differ dramatically (FIGS. 2J-2K). In the progression region (k>k*), agents exploit rapid refinements to improve through past feedback. By contrast, those in the stagnation region (k<k*) do not seem to profit from failure, as their efforts stall in efficiency and saturate in quality. As such, the phase transitions uncovered in the proposed model make four distinct predictions, which were tested directly in the contexts of science, entrepreneurship, and security.

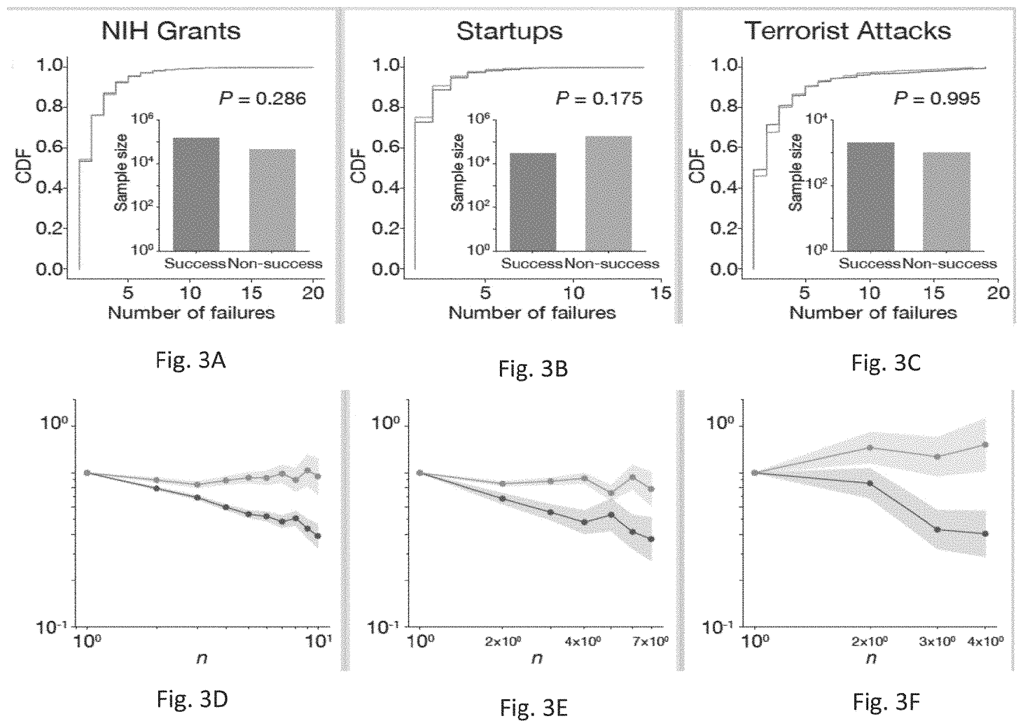

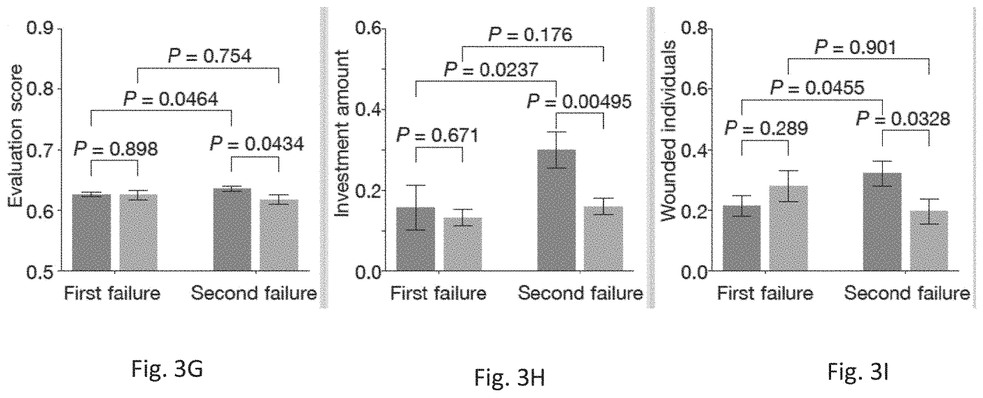

A first prediction based on the above-discussed phase transitions of the proposed model is that not all failures lead to success. While analysis tends to focus on examples that eventually succeeded following failures, the stagnation region predicts that there exists a non-negligible fraction of cases that do not succeed following failures. The number of failed cases that did not achieve eventual success in the three datasets was measured. It was found that members of the unsuccessful group not only exist, but that their size is of similar order of magnitude as the success group (FIGS. 3A-3C). Interestingly, the number of consecutive failures prior to the last attempt for the non-success group follows a statistically indistinguishable distribution from those that lead to success (FIGS. 3A-3C), suggesting that people who ultimately succeeded did not try more or less than their non-successful counterparts.

A second prediction based on the above-discussed phase transitions of the proposed model is that early dynamical signals separate the success group from the non-success group. The model predicts that the success group is characterized by power-law temporal scaling, which is absent for the non-success group (FIG. 2J), predicting the two groups may follow fundamentally different failure dynamics distinguishable at an early stage. To test this prediction, the average inter-event time between two failures Tₙ was measured as a function of the number of failures.

FIGS. 3D-3F unveil three important observations. First, for the success group, Tₙ decays with n across all three domains, approximately following a power law, as captured by Equation 1. The scaling exponents are within a similar range as those reported in learning curves, further supporting the validity of power law scaling. Although the three datasets are among the largest in their respective domains, agents with a large number of failures are exceedingly rare, limiting the range of n that can be measured empirically. A test was therefore conducted to determine if alternative functions may offer a better fit, and power law was found to be the consistently preferred choice. A second observation is that temporal scaling disappears when the same quantity for the non-success group (FIGS. 3D-3F) was measured, consistent with predictions about the stagnation region. The third observation is that the two groups show distinguishable failure dynamics as early as n=2, suggesting intriguing early signals that separate those who eventually succeed from those who do not.

The observations uncovered in FIGS. 3D-3F are intriguing for two main reasons. First, failures captured by the three datasets differ widely in their scope, scale, definition, and temporal resolution. However, despite these differences, they are characterized by remarkably similar dynamical patterns predicted by the proposed model. Second, while one might expect that the last attempt was crucial in separating the two groups, as the model predicts, success and non-success groups each follow their respective, highly predictable patterns, and are distinguishable long before the eventual outcome becomes apparent. Indeed, the data set D₁ was used to set up a prediction task to predict ultimate success or failure using only temporal features, yielding substantial predictive power. To test if the observed patterns in FIGS. 3D-3F may simply reflect preexisting population differences, agents who experienced a large number of failures were considered, and their performance was measured from their first attempt. It was found that for all three domains, the two populations were statistically indistinguishable in their initial performance (FIGS. 3G-3I), which leads to the next prediction.

A third prediction based on the above-discussed phase transitions of the proposed model is that diverging patterns of performance improvement can predict success or failure. Although the two groups may have begun with similar performance, the model predicts they may experience different performance gains through failures (FIG. 2K). Performance at first and second attempts was compared, and there was found to be significant improvement for the success group (FIGS. 3G-3I), which is absent for the non-success group. The measurements were repeated by comparing the first and penultimate or halfway attempt, arriving at the same conclusion. This prediction explains patterns observed in FIGS. 1C-1E, which leads to further consideration of the results depicted in FIG. 1. Namely, consideration of how/why failure streaks are longer than expected if the performance improves as found (FIGS. 1H-1J).

FIG. 3 depicts results from testing the above-discussed model predictions. FIG. 3A depicts a cumulative distribution function (CDF) of the number of consecutive failures prior to the last attempt for the success and non-success groups based on the NIH grant data in accordance with an illustrative embodiment. FIG. 3B depicts a cumulative distribution function (CDF) of the number of consecutive failures prior to the last attempt for the success and non-success groups based on the startup data in accordance with an illustrative embodiment. FIG. 3C depicts a cumulative distribution function (CDF) of the number of consecutive failures prior to the last attempt for the success and non-success groups based on the terrorist attack data in accordance with an illustrative embodiment. To eliminate the possibility that agents were simply in the process of formulating their next attempt, the focus was on cases where it has been at least five years since the last failure. In each of the three datasets, two distributions are statistically indistinguishable (Kolmogorov-Smirnov test for samples with at least one failures). For clarity, results are shown for less than 21 failures. The sample size of success and non-success group, showing their size is of a similar order of magnitude.

FIG. 3D depicts how early temporal signals separate success and non-success groups based on the NIH grant data (n=43705,15132) in accordance with an illustrative embodiment. FIG. 3E depicts how early temporal signals separate success and non-success groups based on the startup data (n=2455,16656) in accordance with an illustrative embodiment. FIG. 3F depicts how early temporal signals separate success and non-success groups based on the terrorist attack data (n=446,321) in accordance with an illustrative embodiment. For each group, the average inter-event time was measured between two failures Tₙ≡tₙ/t₁ as a function of the number of attempts. Dots and shaded areas show the mean and standard error of the mean, measured from data. All success groups manifest power law scaling Tₙ˜n^{-γ}. The two groups show distinguishable temporal dynamics for n=2 (two-sided t-test, P=3.02×10⁻⁴, 7.18×10⁻³, 9.42×10⁻²). This temporal scaling is absent for non-success groups.

FIG. 3G depicts how performance during a first attempt differs from performance of a second attempt for the NIH grant data in accordance with an illustrative embodiment. FIG. 3H depicts how performance during a first attempt differs from performance of a second attempt for the startup data in accordance with an illustrative embodiment. FIG. 3I depicts how performance during a first attempt differs from performance of a second attempt for the terrorist attack data in accordance with an illustrative embodiment. As shown, performance at the first attempt appears indistinguishable between the success and non-success groups who experienced a large number of consecutive failures prior to the last attempt (at least 5 for D₁, 3 for D₂ and 2 for D₃, two-sided t-test). However, performance becomes distinguishable from the second attempt (two-sided t-test). Whereas performance improves for the success group (one-sided t-test), this improvement is absent for the non-success group (one-sided t-test). The center and error bar show the mean and standard error of the mean. In FIG. 3G n=628,145,571,123, in FIG. 3H n=248,1332,237,1312, and in FIG. 3I n=231,173,229,174.

One key difference between the progression and stagnation regimes is the propensity to reuse past components. From the perspective of exploration vs. exploitation, however, reuse helps one retain a good version when it appears. However, such reuse could also keep one in a suboptimal position for longer, suggesting the final prediction, which is that the length of failure streaks follows a Weibull distribution as follows:

P(N≥n)˜e^{-(n/λ)}^{^{β}}. Eq. 2:

Moreover, the shape parameter β is connected with the temporal scaling exponent γ through a scaling identity as follows:

β+γ=1. Eq. 3:

This means that if one fits the streak length distribution in FIGS. 1H-1J to obtain the shape parameter β, it should relate to the temporal scaling exponent γ, obtained from FIGS. 3D-3F. Comparing β and γ measured independently across all three datasets shows consistency between the data and the scaling identity (Equation 4). The robustness of the results was tested along several dimensions, arriving at broadly consistent conclusions.

As a single parameter, k necessarily combines individual, organizational and environmental factors in learning. The one-parameter model described herein represents a minimal model, which can be extended into richer frameworks. For example, agents may have varied incentives to improve or may differ in their confidence and ability to judge their prior work. Such factors trace heterogeneity in the population and can be captured by the α parameter, which quantifies an individual's propensity to change in response to feedback. This leads one to develop the k−α a model, which predicts a two-dimensional phase diagram with three distinct phases. The model can be further extended to capture fuzzy inference from past feedback, allowing agents to not always choose the best prior versions (k−α−δ model).

The model also offers relevant insights for the understanding of learning curves. For example, the second critical point of the model suggests the existence of a minimum number of failures one needs to consider (k*+1), indicating that it is unnecessary to learn from all past experiences to achieve a maximal learning rate. This finding poses a potential explanation for the widespread nature of Wright's law across a wide variety of domains, particularly given the fact that in many of those domains not all past experiences can be considered.

Lastly, as a simple model, the proposed model does not explicitly account for many of the complexities characterizing real settings that may affect failure dynamics, such as knowledge depreciation, competition, forgetting, and transfer, or vicarious learning from others. However, the model offers a theoretical basis to incorporate additional factors, including individual and organizational characteristics that may affect learning (e.g., organizational learning, prior achievements, gender differences, etc.), demonstrating that the proposed modeling framework can serve as a springboard for anchoring future models and analyses.

Together, the results support the hypothesis that if future attempts systematically build on past failures, the dynamics of repeated failures reveal statistical signatures discernible at an early stage. Traditionally the main distinction between ultimate success and failure following repeated attempts has been attributed to differences in luck, learning strategies, or individual characteristics, but the proposed model offers an important new explanation with crucial implications. For example, even in the absence of distinguishing initial characteristics, agents may still experience fundamentally different outcomes. The results unveil identifiable early signals that help one predict the eventual outcome to which failures lead. Together, they not only deepen the understanding of the complex dynamics beneath failure, they also hold lessons for individuals and organizations that experience failure and the institutions that aim to facilitate or hinder an eventual breakthrough.

The parameter k in the proposed model can be viewed as approximating the memory of past versions. The rationale of using k for the model is rooted in the learning literature showing that the general notion of forgetting takes multiple forms, often representing a combination of individual, organizational, and environmental factors. Indeed, several relevant factors may be at play, which can generate patterns similar to forgetting. For example, in rapidly shifting innovation domains, not all past failures remain useful over time, and some become obsolete. Consider the concept of knowledge depreciation, which could also apply in applicable settings as environments (scientific knowledge/capital markets/security situations) evolve over time, such that past experience could become useless even if memorized. For example, an NIH proposal four failures ago may become irrelevant as the ideas proposed have been dispositively proven wrong, or published by the PI or another research group. Similarly, startup ideas from the dot com era may be irrelevant in the era of artificial intelligence (AI) and Blockchain. Terrorist tactics can also depreciate over time, as past strategies attracted media coverage and gave rise to tighter security measures defending against them. This line of reasoning supports the idea that recent attempts are most relevant. It is also consistent with the learning literature, which suggests knowledge forgetting can happen in distinct ways, either voluntarily or involuntarily. Given these factors, a single parameter k was selected to encapsulate a variety of potential contributing factors.

To empirically measure the dynamics of components, the inventors collected abstract information for all R01 NIH grant applications submitted after 2008. A natural language processing (NLP) technique was applied to this data to extract a Medical Subject Headings (MeSH) term from each abstract, which approximate methods, physical states, and processes involved in the proposed research. This allows one to quantify, for the success group, the dynamics of component reuse from prior proposals. The new versions of components were measured by the number of new MeSH terms (terms that did not appear in the previous k submissions, defined as mₙ) and plot Mₙ≡ [symbol] mₙ [symbol] / [symbol] m₁ [symbol] as a function of n. The proposed model suggests that given k, one can use Mₙ to mimic the temporal dynamics of Tₙ. More precisely, for the success group, it is expected that large k (k>k*), Mₙ and Tₙ are characterized by similar dynamics. For small k (k<k*), however, the two quantities could be quite different. The empirical analysis shows that the two curves indeed follow different dynamics for small k (k≤3), but the dynamics of Mₙ and Tₙ become statistically indistinguishable for k>3 (from 4 to ∞), approximately following a power law with γ˜0.35. One cannot directly examine component dynamics for the non-success group due to the lack of sufficient data—by definition agents in this group submitted no proposal after 2010, and the abstract data only go back to 2008.

To understand the nature of two transition points of the proposed model, one can consider a canonical ensemble of N particles (N→∞) and three energy states Eₐ(h)=1, E_{b}(h)=(2h−1)², and E_{c}(h)=1, where h denotes the external field. The partition function of the system can be written as Z=e^{-NE}^{_{α}}^{(h)}+e^{-NE}^{_{b}}^{(h)}+e^{-NE}^{_{c}}^{(h)}, and its free energy density can be calculated as f=1nZ/N. In this system, it can be shown that the magnetization density

$$m = \frac{df}{dh}$$

is discontinuous at me boundary of two energy states Eₐ(h)=E_{b}(h) and E_{b}(h)=E_{c}(h), characterized by two phase transitions at h=0 and h=1, respectively.

It is noted that the canonical ensemble considered above has a mapping to the proposed model. Indeed, denoting with Γ≡k*γ/(1−γ) and K≡k−k*, one can rescale the system as ≡=min{max{≡ₐ(K), ≡_{b}(K)}, ≡_{c}(K)}, where ≡ₐ(K)=0, ≡_{b}(K)=K, and ≡_{c}(K)=1, allowing one to map the two systems through f →(2≡−1)², N→lnn, h→K, and Eᵢ(h)=[2≡ᵢ²(K)−1]².

To understand the origin of the two transition points, the expected life span of a high-quality version can be calculated, obtaining [symbol] u(x) [symbol] ˜ [symbol] (1−x)^{-min{k/k*,1/k*+1}} [symbol] . The first critical point k* occurs when the first moment [symbol] u [symbol] diverges. Indeed, when k is small (k<k*), [symbol] u [symbol] is finite, indicating that high-quality versions can only be reused for a limited period. Once k passes the critical point k*, however, [symbol] u [symbol] diverges, offering the possibility for a high-quality version to be retained for an unlimited period of time. The second critical point arises due to the competition between two dynamical forces: (i) whether the current best version becomes forgotten after k consecutive attempts in creating new versions (dominated by the k/k* term); or (ii) it is substituted by an even better version (dominated by the 1/k*+1 term).

It is noted that while phase transitions carry exceptional importance in statistical physics, similar phenomena and concepts are also of fundamental relevance in the social/behavioral science literature. For example, critical thresholds have been observed and modeled in social settings ranging from shifts in neighborhood segregation to social network formation to collective opinion change. In each case, slight shifts in micro-scale phenomena, like average preference, group size, or interaction intensity, condition a qualitative transition in macro-scale outcomes.

To better understand the role of heterogeneity in learning, the inventors separated the success group into narrow-win and clear-win subgroups based on their eventual performance. It was found find that, despite their eventual difference, the temporal dynamics of the two groups remain statistically indistinguishable (two-sided t-test, P=0.763(D₁),0.813(D₂),0.259(D₃), suggesting that the distinction between success and non-success group appears the most critical, whereas agents within the success group are characterized by similar dynamics, consistent with the predictions of the proposed model.

An alternative interpretation for the stalled efficiency of the non-success group is a hedging behavior against failures (i.e., their efficiency did not improve because they spent more effort elsewhere). The three actions studied, ranging from NIH investigators to entrepreneurs to terrorists, involve varied levels of risk, exposure, and commitment, which renders such an explanation less likely.

To test the robustness of the results, the definitions of success group were varied by excluding revisions in D₁, changing the threshold of high-value mergers and acquisitions or controlling for unicorn companies in D₂, and oaring types of attacks or changing the threshold for fatal attacks in D₃. The definition of non-success groups was also varied, and other were measures tested to approximate performance. Adjustment for temporal variation was done by controlling for overall success rate across different years. Across all variations, the conclusions remain the same.

A simple logistic model was used to predict whether one may achieve success following N previously failed attempts in D₁, using only temporal features tₙ (1≤n≤N−1) as predictors. To evaluate prediction accuracy, the AUC curve was calculated over 10-fold cross validation. It was found that by observing timing of the first three failures alone, the simple temporal feature yields high accuracy in predicting the eventual outcome with an AUC close to 0.7, which is significantly higher than random guessing (Mann-Whitney rank test, P<10⁻¹⁸⁰). The same prediction task was repeated on D₂ and D₃, arriving at similar conclusions. The predictive power from temporal features alone is somewhat unexpected. Indeed, there are a large number of documented factors that affect the outcome of a grant application, ranging from prior success rate to publication and citation records to race and ethnicity of the applicant. Yet here these factors were ignored, and only features pertaining to temporal scaling were used as prescribed by the model. This suggests that the predictive power represents a lower-bound, which could be further improved and leveraged by incorporating additional factors.

Agents may differ in the judgment of their own work or incentives to change given feedback, which can be captured by varying the a parameter in the original k-model. Of the many influences on p, one key factor is the quality of existing versions, suggesting that p should be a function of x*. Considering the two extreme cases, if x*→0, existing versions of this component have among the worst scores and, hence, a high potential for improvement when replaced with a new version. Indeed, the likelihood of creating a new version is high, i.e., p→1. On the other hand, x*→1 corresponds to a near-perfect version, yielding a decreased incentive to create a new one (p→0). Also, P(x≥x*)=1−x* captures the potential to improve on prior versions, prompting one to assume p=(1−x*)^{α}, where α>0 characterizes an agent's propensity to create new versions given the quality of existing ones. Therefore, α→0 indicates that regardless of one's evaluation, the agent will always create a new version, whereas α→∞ points to the other extreme where one does not create a new version unless it is extremely bad. Considering α as another tunable parameter, one arrives at a two-parameter model: the k−α model.

To solve this model, one can substitute k* with 1/α, and the indexes k/k* and 1/k*+1 then becomes kα and α+1. The extended model thus predicts the existence of three different phases on a two-dimensional phase diagram, with the boundaries kα=1 and (k−1)α=1 that separate the three phases. The k−α model reduces back to the two critical points in the original k model when α is fixed. The two parameters jointly define an ‘effective’ K≡k−k*=k−1/α. The critical boundaries therefore reduce into two simple equations: K=0 and K=1. It is noted that the assumed relationship between p and (1−x*) is not limited to a power law but can be relaxed into its asymptotic form. Indeed, it was shown that as long as the function satisfies

$$\frac{ln p}{ln ( 1 - {ϰ}^{*} )} \to α$$

as x*→1, the model offers the same predictions.

A k−α−δ model was also explored. Agents may have fuzzy inference of past feedback, and hence may not always choose the version with the highest quality. One can model the choice between different versions in a probabilistic fashion, by introducing a δ parameter to the k−α model. Here the probability to choose the i-th version as a baseline follows

$$P ( i ) = \frac{1}{Z} {( 1 - {x}_{i} )}^{- δ} {1}_{n - k \leq i \leq n - 1} ,$$

where Z is the normalization factor, Z≡Σᵢ₌ₙ₋ₖⁿ⁻¹ (1−xᵢ)^{-δ}. The term δ=0 means one cannot differentiate quality between past versions and selects randomly among different versions, whereas δ→∞ indicates that one always chooses the prior version with the highest quality, converging back to the original k model or the k−α model. Incorporating δ leads to the k−α−δ model.

Analytically solving the model reveals interesting scaling behaviors based on δ. Indeed, it was found that the scaling behavior of the system follows γ(k, α, δ)=1−{max[min(α+(k−1)min{1, α, δ}, α+1),1]}⁻¹, revealing rich mathematical properties. When δ→∞, the new solutions converge back to the original solution for the k−α a model. With δ the three-parameter model is characterized by four different phases. Three of the regimes are generalizations of those found in the k−α model, where the scaling exponent γ does not depend on δ in the limit of δ→∞, i.e., γ(k, α, δ)=γ(k, α, ∞). The fourth one, however, is a new phase and only exists for small δ. The intuition is that, in this regime, the inability to select a high-quality version (small δ) dominates the scaling behavior, with exponent γ(k, α, δ)=1−[(k−1)δ+α]⁻¹.

Together, these extensions offer further support for the predictions of the original model, while demonstrating the model's theoretical potential by enriching its mathematical properties with more realistic interpretations. They also point to promising future research that explores the interplay between different perspectives of learning. It is noted that while all three variations of the model predict the existence of different phases, a primary interest concerns the fundamental differences in the nature of these regimes (i.e., stagnation vs progression), rather than the behavior of the system as it approaches the critical threshold. As such, the conclusions reached hold the same regardless of any specific critical behavior around the threshold.

The proposed model also offers a new framework to anchor potential factors relevant to learning. As an example, three different factors were tested. First, the literature has identified several factors for the emergence of learning at the level of organizations, suggesting that individual learning is just one factor in how and why organizations may learn. This suggests that settings closer to organizational learning (such as terrorist groups) should correspondingly experience higher learning rates than those closer to individual learning (such as NIH PIs). This hypothesis was tested by calculating the average scaling exponent γ measured from the data, and it was found that the estimations support it, with learning rates lowest for individual researchers, higher for entrepreneurs and their founding teams, and higher still for terrorist organizations. While these results show consistency with the theories from the organizational learning literature, these differences could also be due to inherent domain-specific differences.

Second, higher prior achievements often bring recognition and resources, a phenomena referred to as the Matthew Effect, which might translate into higher learning rates. To test this, NIH grant application data was linked to Web of Science citation database through a systematic effort of disambiguating authors, and the citations of prior research papers were matched with the submitted proposals. The PIs who failed more than three times before their eventual success were considered, and the total number of citations of each PI was calculated for all his/her papers published before the first failure, with a finding that the prior acclaim is positively and significantly correlated with learning rate γ(P<0.001).

Third, persistent gender inequalities in science and entrepreneurship suggest the possibility that failure dynamics may be mediated by gender. A regression analysis reveals a significant correlation between gender and learning rate. All else being equal, the learning rate γ of a male PI in NIH system exceeds that of a female PI by 0.14 (P=0.001), showing that male PIs fail faster than their female colleagues. This difference appears substantial, considering that the average learning rate is centered around 0.35. This relationship was further tested in the startup dataset, and a similar gap of 0.10 between male and female innovators was found. This result is not as significant, possibly due to a smaller sample size. It is noted that these gender differences may flow from institutional as well as individual causes, such as a culture that discourages women from persistence and encourages oversensitivity to feedback. Indeed, one irony suggested by the proposed model is that agents in the stagnation region did not work less. Rather they made more, albeit unnecessary modifications to what were otherwise advantageous experiences.

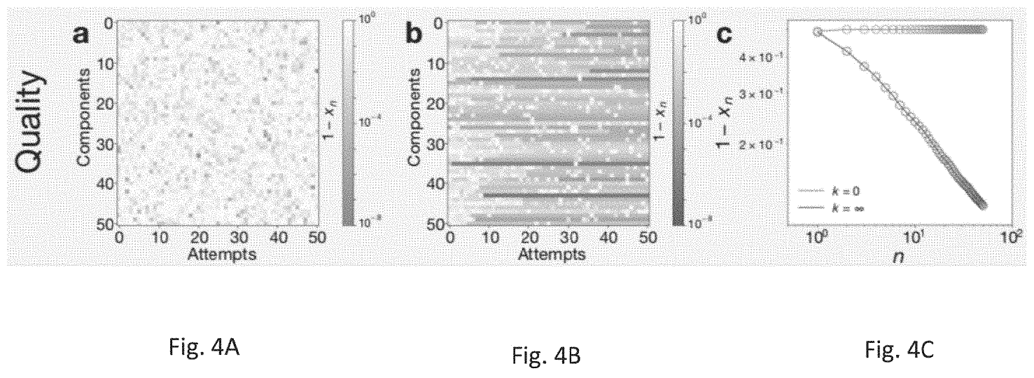

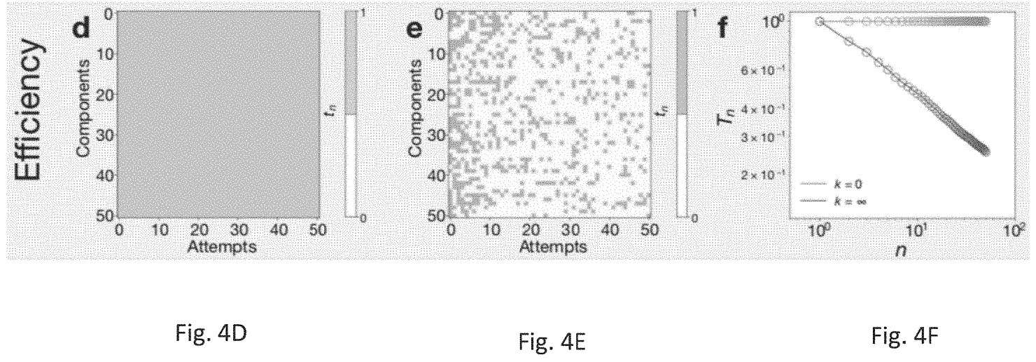

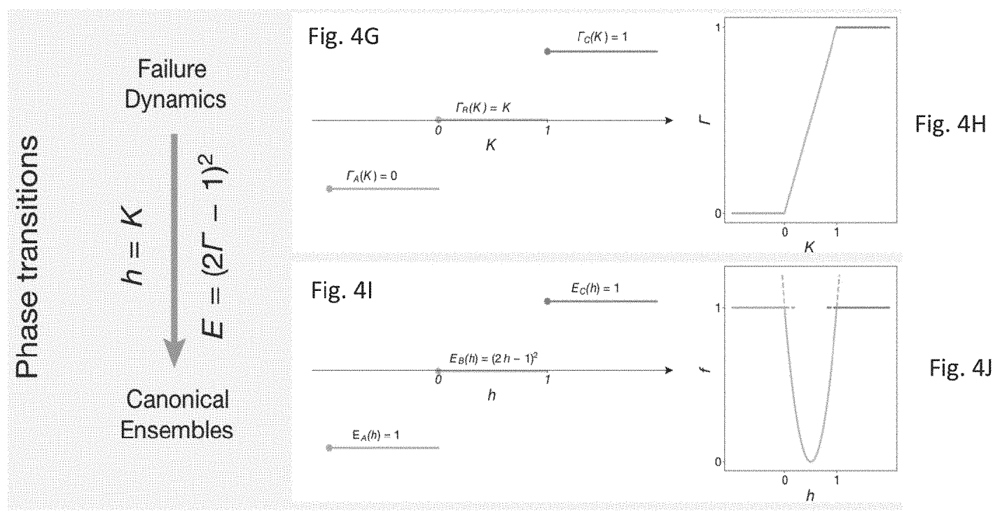

FIG. 4A depicts simulation results from a k model with α=0.6 for k=0 in terms of average quality in accordance with an illustrative embodiment. FIG. 4B depicts simulation results from a k model with α=0.6 for k→∞ in terms of average quality in accordance with an illustrative embodiment. FIG. 4C depicts a comparison of k=0 and k→∞ in terms of average quality in accordance with an illustrative embodiment. FIG. 4D depicts simulation results from a k model with α=0.6 for k=0 in terms of average efficiency in accordance with an illustrative embodiment. FIG. 4E depicts simulation results from a k model with α=0.6 for k→∞ in terms of average efficiency in accordance with an illustrative embodiment. FIG. 4F depicts a comparison of k=0 and k→∞ in terms of average efficiency in accordance with an illustrative embodiment. As shown, k=0 recovers the chance model, predicting a constant quality and efficiency.

As the term k→∞, it predicts temporal scaling that characterizes the dynamics of failure with improved quality, recovering predictions from learning curves and Wright's Law. FIG. 4G is a first depiction of mapping between failure dynamics in accordance with an illustrative embodiment. FIG. 4H is a second depiction of mapping between failure dynamics in accordance with an illustrative embodiment. FIG. 4I is a first depiction of mapping of canonical ensembles in accordance with an illustrative embodiment. FIG. 4J is a second depiction of mapping of canonical ensembles in accordance with an illustrative embodiment. The canonical system is characterized by three different states a, b, c with corresponding energy density Eₐ(h), E_{b}(h), E_{c}(h). Here it is assumed that Eₐ(h)=(2εh−1)², E_{b}(h)=(2h−1)², and E_{c}(h)=[2ε(1−h)−1]², where ε→0⁺. The introduction of ε is to distinguish state α from state c, both of which can be approximated in the limiting condition Eₐ(h)=E_{c}(h)=0. One can map f→(2Γ−1)², N→lnn, h→K, and Eᵢ(h)=[2Γᵢ(K)−1]². In this case, the two transition points k* and k*+1 correspond to h=0 and 1 in the canonical ensemble systems.

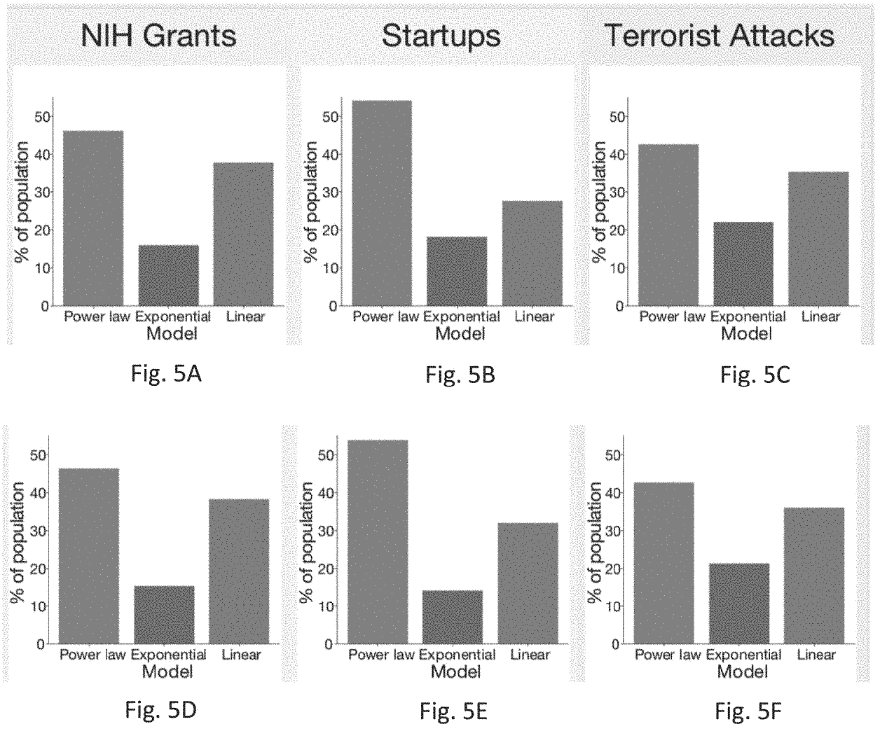

FIG. 5 depicts predictions of temporal dynamics in science, entrepreneurship and security. Specifically, FIG. 5A compares the goodness of fit for three different models (i.e., power law, exponential, and linear) in NIH grants in accordance with an illustrative embodiment. FIG. 5B compares the goodness of fit for three different models (i.e., power law, exponential, and linear) in startups in accordance with an illustrative embodiment. FIG. 5C compares the goodness of fit for three different models (i.e., power law, exponential, and linear) in terror attacks in accordance with an illustrative embodiment. In FIG. 5A n=10345, in FIG. 5B n=275, and in FIG. 5C n=136. For each individual sample, all but the last inter-event time was taken for model fitting (n=1, . . . , N−1), comparing model predictions for the last inter-event time. The tested functional forms are power law: tₙ=αn^{b}, exponential: tₙ=αb⁻ⁿ and linear: tₙ=α+bn, respectively. The frequency at which each model reaches minimum error, defined as |log(t_{N})−log(\hat{t}_{N})|, was also calculated among all three forms. As shown, the power law model offers consistently better predictions. FIG. 5D depicts the goodness of fit for the three different models using |t_{N}31 \hat{t}_{N}| as the loss function for the NIH grant data in accordance with an illustrative embodiment. FIG. 5E depicts the goodness of fit for the three different models using |t_{N}31 \hat{t}_{N}| as the loss function for the startup data in accordance with an illustrative embodiment. FIG. 5F depicts the goodness of fit for the three different models using |t_{N}−\hat{t}_{N}| as the loss function for the terror attack data in accordance with an illustrative embodiment.

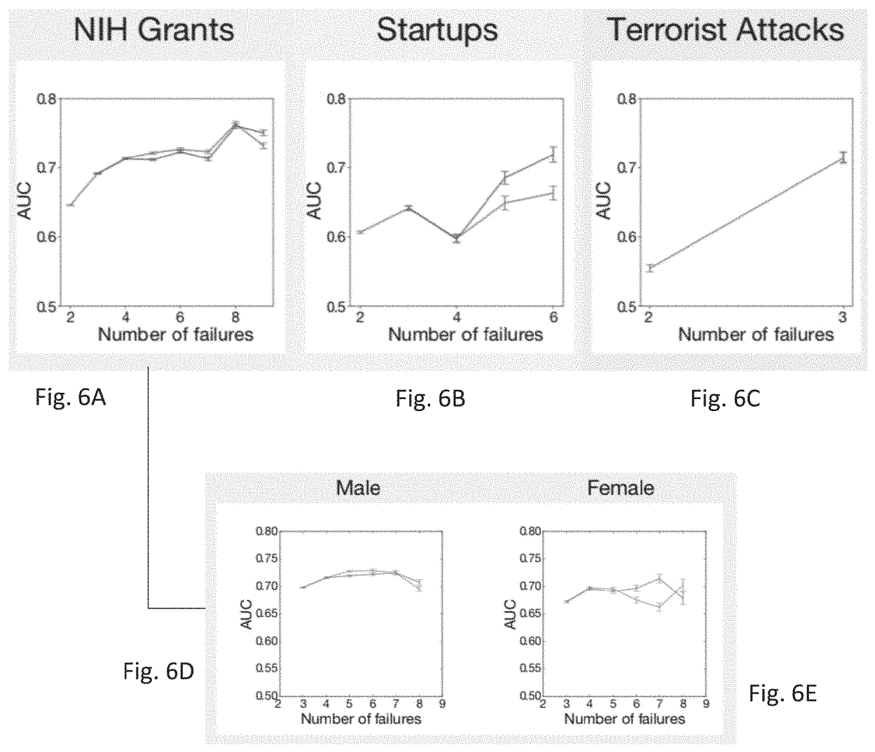

FIG. 6A depicts Area Under the curve of the Receiver Operating Characteristic (AUROC) of the prediction task for the NIH grant data in accordance with an illustrative embodiment. FIG. 6B depicts AUROC of the prediction task for the startup data in accordance with an illustrative embodiment. FIG. 6C depicts AUROC of the prediction task for the terror attack data in accordance with an illustrative embodiment. Two logistic regression models were used to predict ultimate success in NIH grants (FIG. 6A), startups (FIG. 6B), and terrorist attacks (FIG. 6C). The centers and error bars of AUROC scores denote the means and standard error of the mean calculated from 10-fold cross validation over 50 randomized iterations (green: Model 1, red: Model 2). FIG. 6D shows prediction of ultimate success in NIH grantes for male investigators in accordance with an illustrative embodiment. FIG. 6E shows prediction of ultimate success in NIH grantes for female investigators in accordance with an illustrative embodiment.

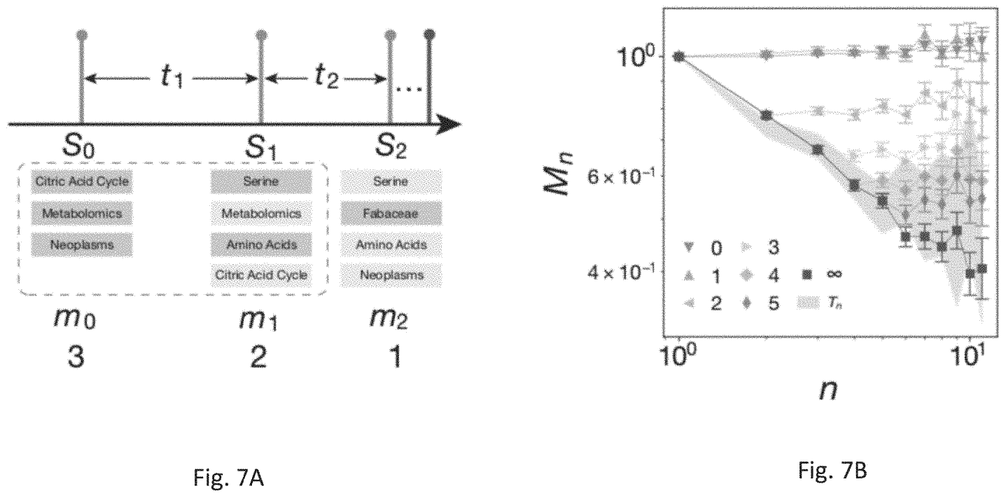

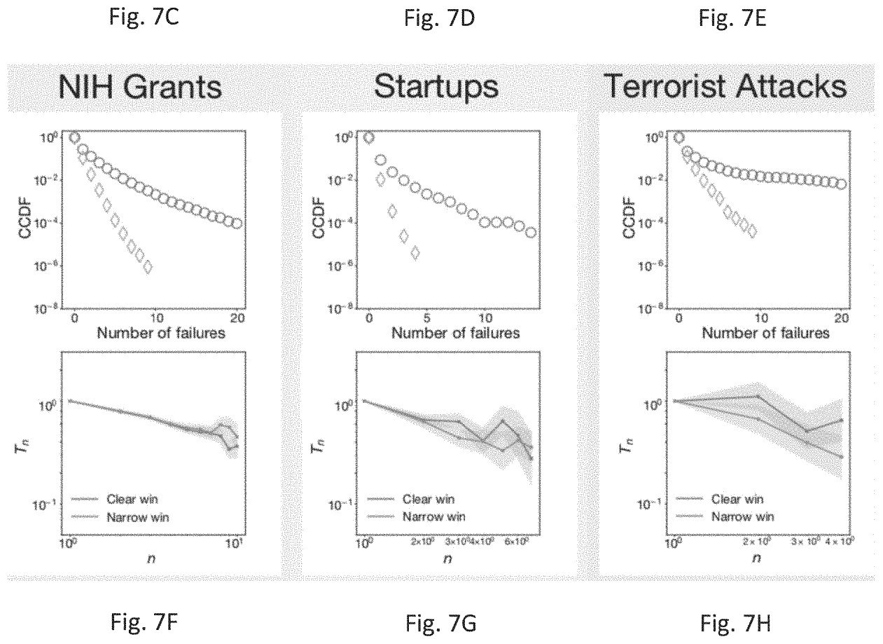

FIG. 7A is a first illustration depicting component dynamics in accordance with an illustrative embodiment. FIG. 7B is a second illustration depicting component dynamics in accordance with an illustrative embodiment. All MeSH terms associated with the n-th attempt, Sₙ, were extracted and the number of new terms mₙ, was calculated, defined as |Sₙ−(Sₙ₋₁ ∪ . . . ∪ Sₙ₋ₖ)|. FIG. 7B depicts the testing of component dynamics in NIH grant applications. The dynamics of Mₙ= [symbol] mₙ [symbol] / [symbol] m₁ [symbol] were calculated using different k and were compared with Tₙ. The centers and error bars of Mₙ show the means and s.e.m. (n=5899) for different k. The shaded area shows mean±s.e.m. of Tₙ (logged) measured on the same subset. As shown, all k>3 lead to similar trends between Mₙ and Tₙ.

FIG. 7C depicts length of failure streak after randomization for the NIH grant data in accordance with an illustrative embodiment. FIG. 7D depicts length of failure streak after randomization for the startup data in accordance with an illustrative embodiment. FIG. 7E depicts length of failure streak after randomization for the terror attack data in accordance with an illustrative embodiment. To obtain this data, the samples from FIG. 1 were used, and the success/failure label from each attempt was shuffled. This operation keeps constant both the overall success rate and the total number of attempts for each individual. FIG. 7F depicts temporal scaling patterns within the success group for the NIH grant data in accordance with an illustrative embodiment. FIG. 7G depicts temporal scaling patterns within the success group for the startup data in accordance with an illustrative embodiment. FIG. 7H depicts temporal scaling patterns within the success group for the terror attack data in accordance with an illustrative embodiment. For FIGS. 7F-7H, the success group was separated into two subgroups (narrow winners and clear winners) based on eventual performance (0.9 in evaluation score for D₁, 0.5 in investment amount for D₂, and 1 in wounded individuals for D₃). The shaded area shows mean±s.e.m. of Tₙ (logged).

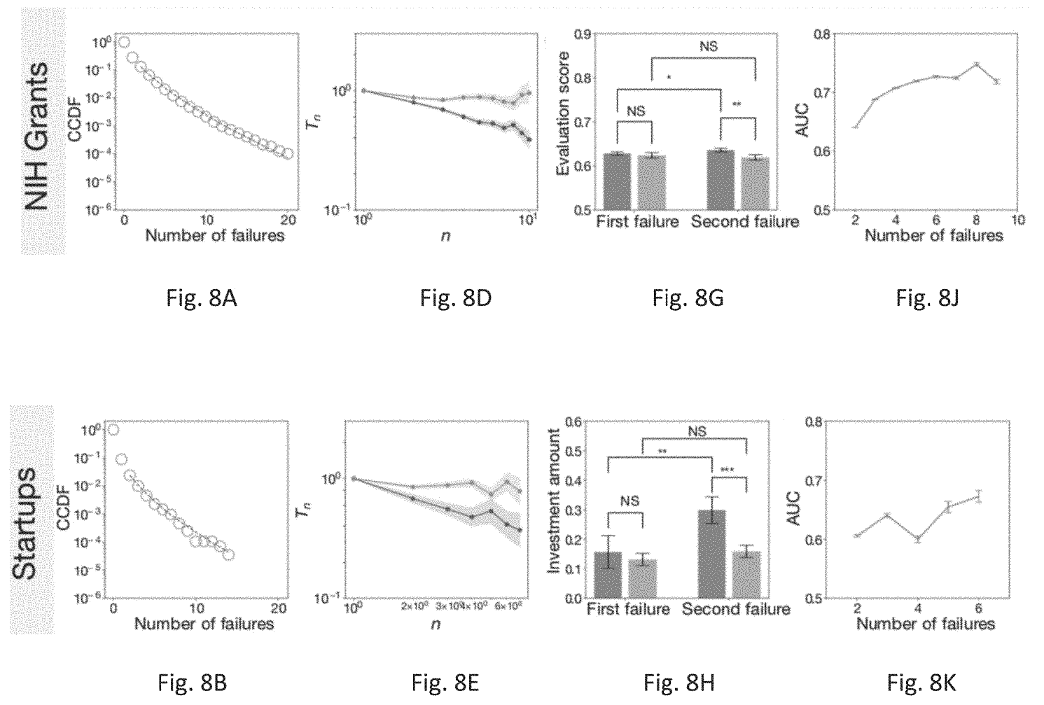

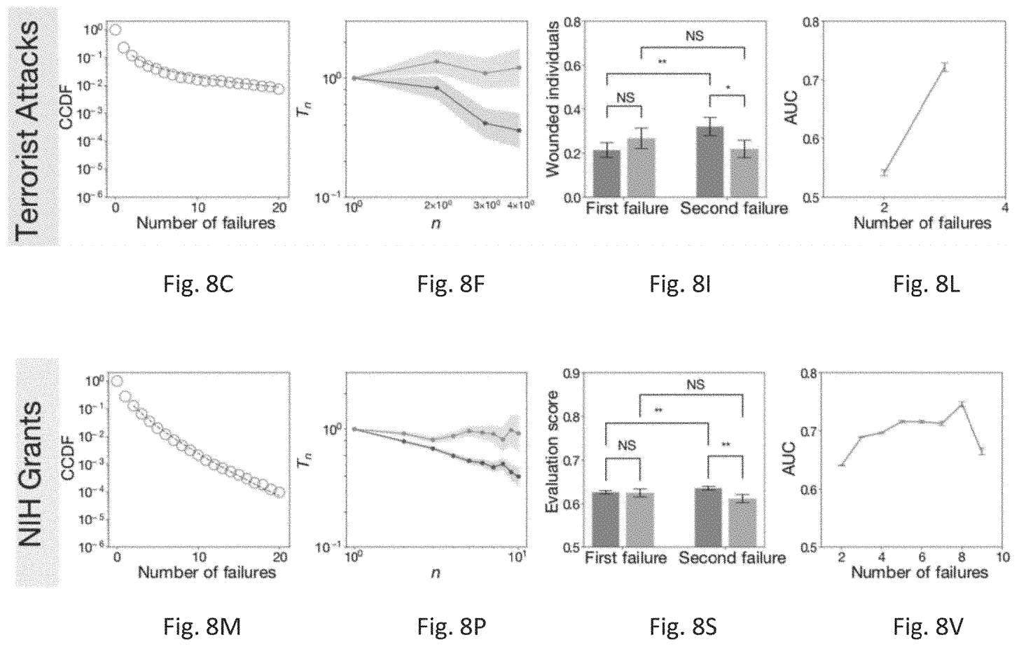

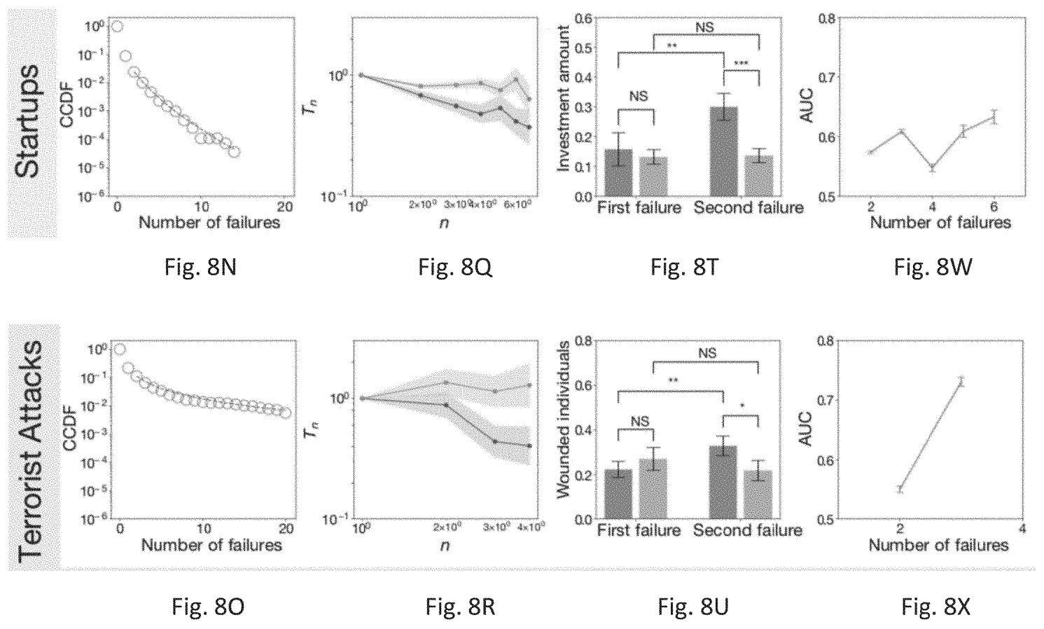

FIG. 8A depicts robustness of the model in terms of number of failures for the NIH grant data with a 3 year threshold of inactivity in accordance with an illustrative embodiment. FIG. 8B depicts robustness of the model in terms of number of failures for the startup data with a 3 year threshold of inactivity in accordance with an illustrative embodiment. FIG. 8C depicts robustness of the model in terms of number of failures for the terror attack data with a 3 year threshold of inactivity in accordance with an illustrative embodiment. Circles represent real data of success group and dashed lines represent fitting of Weibull distributions. FIG. 8D depicts temporal scaling patterns for the NIH grant data in accordance with an illustrative embodiment. FIG. 8E depicts temporal scaling patterns for the startup data in accordance with an illustrative embodiment. FIG. 8F depicts temporal scaling patterns for the terror attack data in accordance with an illustrative embodiment. The shaded area shows mean±standard error of the mean (s.e.m.) of Tₙ (logged).

FIG. 8G depicts performance dynamics for the NIH grant data in accordance with an illustrative embodiment. FIG. 8H depicts performance dynamics for the startup data in accordance with an illustrative embodiment. FIG. 8I depicts performance dynamics for the terror attack data in accordance with an illustrative embodiment. In FIG. 8G n=641,231,578,190, in FIG. 8H n=248,1332,237,1312, and in FIG. 8I n=238,198,236,199. As shown, the success and non-success groups who experienced a large number of consecutive failures prior to the last attempt (at least 5 for D₁, 3 for D₂ and 2 for D₃) appear indistinguishable in first failures (two-sided t-test, P=0.566,0.671,0.349) but quickly diverge in second failures (two-sided t-test, P=2.09×10⁻², 4.95×10⁻³, 7.77×10⁻²). The success group also shows significant performance improvement (one-sided t-test, P=7.03×10⁻², 2.37×10⁻², 2.32×10⁻²), which is absent for the non-success group (one-sided t-test, P=0.717,0.176,0.786). The centers and error bars denote the mean and s.e.m.

FIG. 8J depicts an AUROC score of predicting ultimate success in the NIH grant data in accordance with an illustrative embodiment. FIG. 8K depicts an AUROC score of predicting ultimate success in the startup data in accordance with an illustrative embodiment. FIG. 8L depicts an AUROC score of predicting ultimate success in the terror attack data in accordance with an illustrative embodiment. The centers and error bars of AUROC scores denote the mean and s.e.m calculated from 10-fold cross validation over 50 randomized iterations. In all of FIGS. 8A-8L, 3 years was used as the threshold of inactivity.

FIG. 8M depicts robustness of the model in terms of number of failures for the NIH grant data with a 7 year threshold of inactivity in accordance with an illustrative embodiment. FIG. 8N depicts robustness of the model in terms of number of failures for the startup data with a 7 year threshold of inactivity in accordance with an illustrative embodiment. FIG. 8O depicts robustness of the model in terms of number of failures for the terror attack data with a 7 year threshold of inactivity in accordance with an illustrative embodiment. FIG. 8P depicts temporal scaling patterns for the NIH grant data (7 year threshold of inactivity) in accordance with an illustrative embodiment. FIG. 8Q depicts temporal scaling patterns for the startup data (7 year threshold of inactivity) in accordance with an illustrative embodiment. FIG. 8R depicts temporal scaling patterns for the terror attack data (7 year threshold of inactivity) in accordance with an illustrative embodiment.

FIG. 8S depicts performance dynamics for the NIH grant data (7 year threshold of inactivity) in accordance with an illustrative embodiment. FIG. 8T depicts performance dynamics for the startup data (7 year threshold of inactivity) in accordance with an illustrative embodiment. FIG. 8U depicts performance dynamics for the terror attack data (7 year threshold of inactivity) in accordance with an illustrative embodiment. FIG. 8V depicts an AUROC score of predicting ultimate success in the NIH grant data (7 year threshold of inactivity) in accordance with an illustrative embodiment. FIG. 8W depicts an AUROC score of predicting ultimate success in the startup data (7 year threshold of inactivity) in accordance with an illustrative embodiment. FIG. 8X depicts an AUROC score of predicting ultimate success in the terror attack data (7 year threshold of inactivity) in accordance with an illustrative embodiment. In FIG. 8S n=620,101,559,76, in FIG. 8T n=248,977,237,989, in FIG. 8U n=216,152,214,153. The P-values used are P=0.883,0.671,0.456; P=2.25×10⁻², 1.38×10⁻³, 8.34×10⁻²; P=4.59×10⁻², 2.37×10⁻², 3.33×10⁻²; P=0.838,0.446,0.775. *: P<0.1, **: P<0.05, ***: P<0.01, NS: P≥0.1.

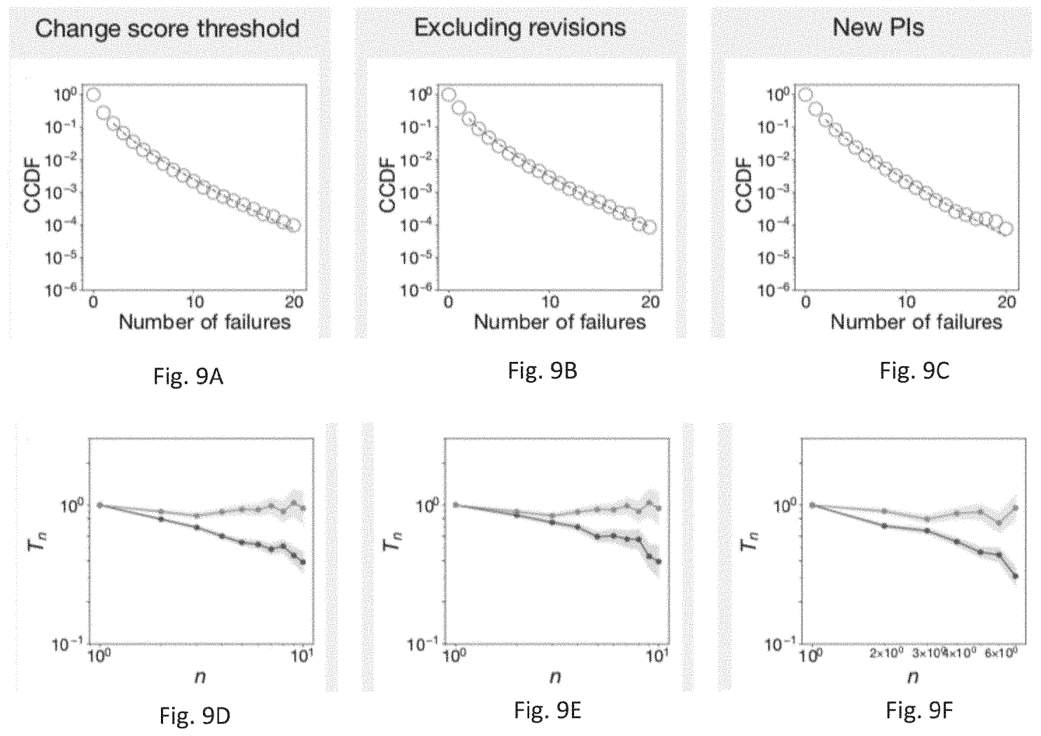

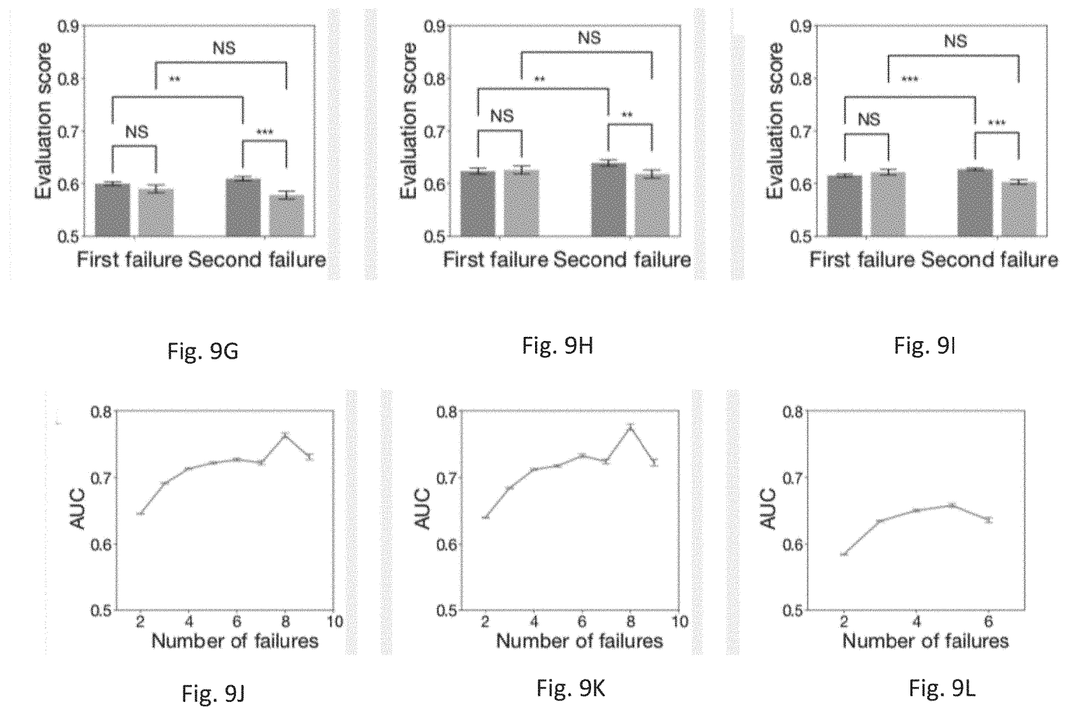

FIGS. 9A-9L illustrate a robustness check on the dataset Dᵢ (i.e., NIH grant data). Specifically, FIG. 9A depicts the failure streak with a score threshold of 55 in accordance with an illustrative embodiment. FIG. 9B depicts the failure streak excluding revisions as successes in accordance with an illustrative embodiment. FIG. 9C depicts the failure streak for new PIs without previous grants in accordance with an illustrative embodiment. Circles represent real data of success group and dashed lines represent fitting of Weibull distributions. FIG. 9D depicts the temporal scaling pattern for a score threshold of 55 in accordance with an illustrative embodiment. FIG. 9E depicts the temporal scaling pattern excluding revisions as successes in accordance with an illustrative embodiment. FIG. 9F depicts the temporal scaling pattern for new PIs without previous grants in accordance with an illustrative embodiment. The shaded area shows mean±s.e.m. of Tₙ (logged).

FIG. 9G depicts performance dynamics with a score threshold of 55 in accordance with an illustrative embodiment. FIG. 9H depicts performance dynamics excluding revisions as successes in accordance with an illustrative embodiment. FIG. 9I depicts performance dynamics for new PIs without previous grants in accordance with an illustrative embodiment. In FIG. 9G n=768,189,686,170, in FIG. 9H n=252,145,216,123, and in FIG. 9I n=1164,308,1530,334. As shown, the success and non-success groups who experienced a large number of consecutive failures prior to the last attempt (at least 5 for g,h and 3 for i) appear indistinguishable in first failures (two-sided t-test, P=0.242,0.819,0.289) but quickly diverge in second failures (two-sided t-test, P=3.40×10⁻⁴, 3.40×10⁻², 9.70×10⁻⁷). The success group also shows significant performance improvement (one-sided t-test, P=4.23×10⁻², 3.04×10⁻², 1.92×10⁻⁴), which is absent for the non-success group (one-sided t-test, P=0.863,0.754,0.997). The centers and error bars denote the mean and s.e.m.

FIG. 9J depicts the AUROC score of predicting ultimate success with a score threshold of 55 in accordance with an illustrative embodiment. FIG. 9K depicts the AUROC score of predicting ultimate success with exclusion of revisions as successes in accordance with an illustrative embodiment. FIG. 9L depicts the AUROC score of predicting ultimate success for new PIs without prior grants in accordance with an illustrative embodiment. The centers and error bars of AUROC scores denote the mean and s.e.m calculated from 10-fold cross validation over 50 randomized iterations. *: P<0.1, **: P<0.05, ***: P<0.01, NS: P≥0.1.

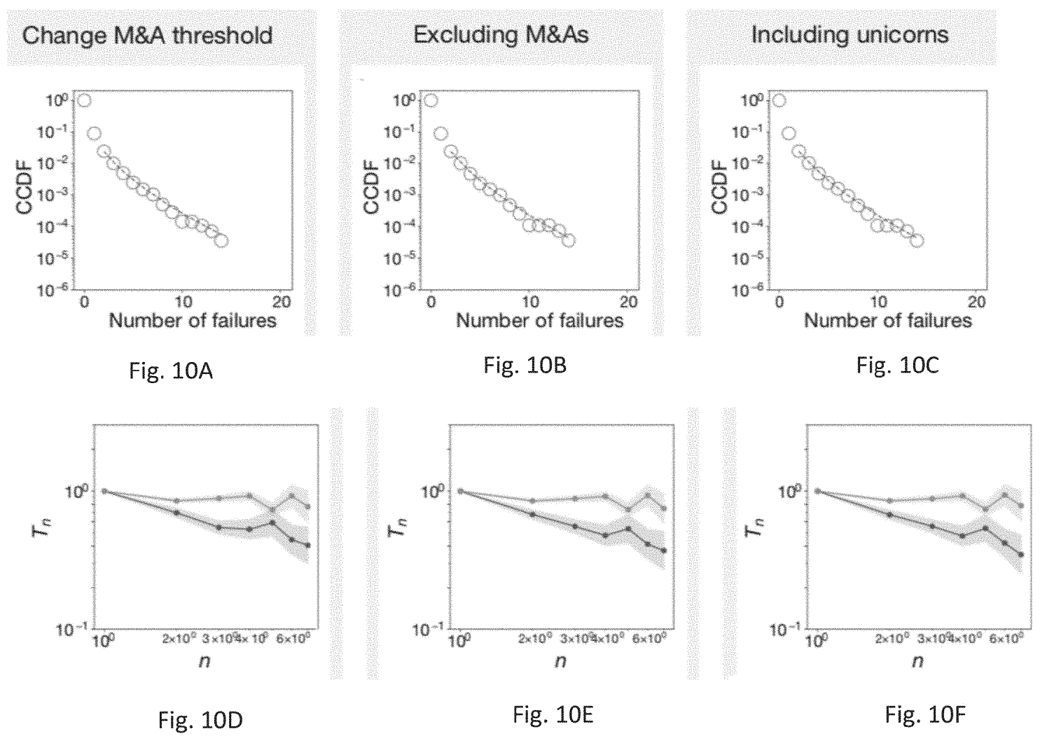

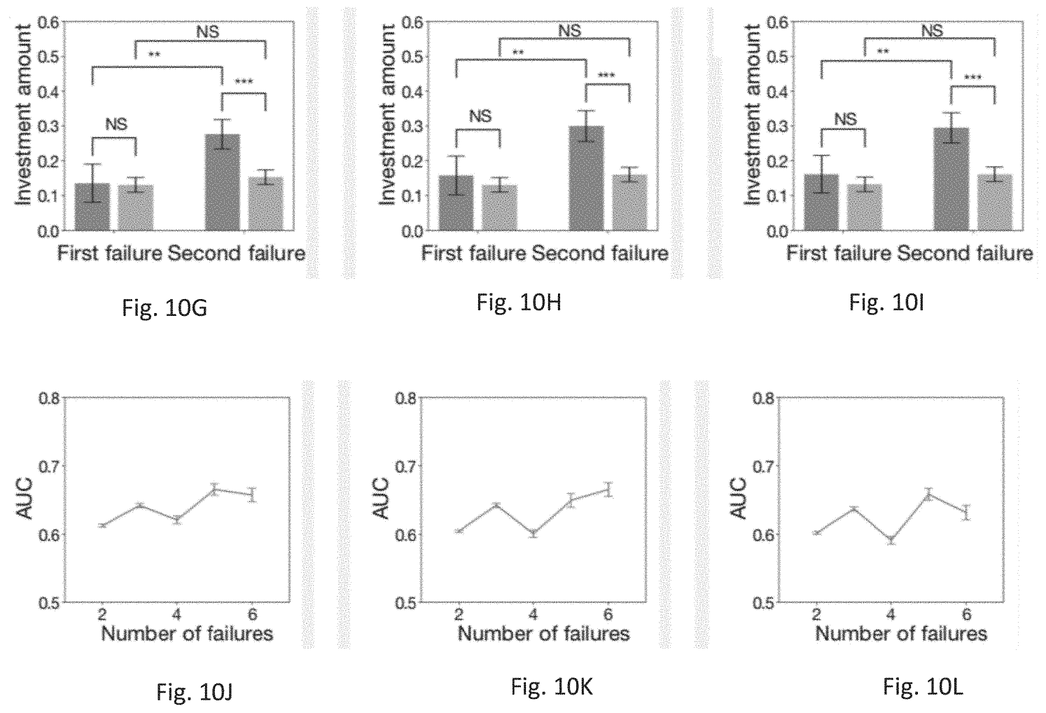

FIGS. 10A-10L illustrate a robustness check on the dataset D₂ (i.e., startup data). FIG. 10A depicts the failure streak with a threshold of high-value M&A set at 5% in accordance with an illustrative embodiment. FIG. 10B depicts the failure streak excluding M&As as successes in accordance with an illustrative embodiment. FIG. 10C depicts the failure streak with unicorns classified as successes in accordance with an illustrative embodiment. Circles represent real data of success group and dashed lines represent fitting of Weibull distributions. FIG. 10D depicts the temporal scaling pattern with a threshold of high-value M&A set at 5% in accordance with an illustrative embodiment. FIG. 10E depicts the temporal scaling pattern excluding M&As as successes in accordance with an illustrative embodiment. FIG. 10F depicts the temporal scaling pattern with unicorns classified as successes in accordance with an illustrative embodiment. The shaded area shows mean±s.e.m. of Tₙ. (logged).

FIG. 10G depicts performance dynamics with a threshold of high-value M&A set at 5% in accordance with an illustrative embodiment. FIG. 10H depicts performance dynamics excluding M&As as successes in accordance with an illustrative embodiment. FIG. 10I depicts performance dynamics with unicorns classified as successes in accordance with an illustrative embodiment. In FIG. 10G n=251,1304,243,1284, in FIG. 10H n=248,1335,237,1315, and in FIG. 10I n=257,1330,244,1311. The success and non-success groups who experienced a large number of consecutive failures prior to the last attempt (at least 3) appear indistinguishable in first failures (two-sided t-test, P=0.937,0.647,0.620) but quickly diverge in second failures (two-sided t-test, P=9.92×10⁻³, 4.94×10⁻³, 6.33×10⁻³). The success group also shows significant performance improvement (one-sided t-test, P=2.16×10⁻², 2.37×10⁻², 2.77×10⁻²), which is absent for the non-success group (one-sided t-test, P=0.224,0.158,0.167). The centers and error bars denote the mean and s.e.m.

FIG. 10J depicts the AUROC score of predicting ultimate success with a threshold of high-value M&A set at 5% in accordance with an illustrative embodiment. FIG. 10K depicts the AUROC score of predicting ultimate success excluding M&As as successes in accordance with an illustrative embodiment. FIG. 10L depicts the AUROC score of predicting ultimate success with unicorns classified as successes in accordance with an illustrative embodiment. The centers and error bars of AUROC scores denote the mean and s.e.m calculated from 10-fold cross validation over 50 randomized iterations. *: P<0.1, **: P<0.05, ***: P<0.01, NS: P≥0.1.

FIGS. 11A-11O illustrate a robustness check on the dataset D₃ (i.e., terror attack data). FIG. 11A depicts the failure streak over all samples in accordance with an illustrative embodiment. FIG. 11B depicts the failure streak over samples of human-targeted attacks in accordance with an illustrative embodiment. FIG. 11C depicts the failure streak for samples that include vague data on fatality in accordance with an illustrative embodiment. Circles represent real data of success group and dashed lines represent fitting of Weibull distributions. FIG. 11D depicts the temporal scaling pattern over all samples in accordance with an illustrative embodiment. FIG. 11E depicts the temporal scaling pattern over samples of human-targeted attacks in accordance with an illustrative embodiment. FIG. 11F depicts the temporal scaling pattern over samples that include vague data on fatality in accordance with an illustrative embodiment. The shaded area shows mean±s.e.m. of Tₙ. (logged).

FIG. 11G depicts performance dynamics over all samples in accordance with an illustrative embodiment. FIG. 11H depicts performance dynamics over samples of human-targeted attacks in accordance with an illustrative embodiment. FIG. 11I depicts performance dynamics over samples that include vague data on fatality in accordance with an illustrative embodiment. In FIG. 11G n=231,231,229,232, in FIG. 11H n=176,173,173,174, and in FIG. 11I n=227,147,225,148. The success and non-success groups who experienced a large number of consecutive failures prior to the last attempt (at least 2) appear indistinguishable in first failures (two-sided t-test, P=0.400,0.859,0.395), but quickly diverge in second failures (two-sided t-test, P=2.08×10⁻³, 6.70×10⁻³, 3.76×10⁻³). The success group also shows significant performance improvement (one-sided t-test, P=2.55×10⁻², 5.65×10⁻², 3.77×10⁻²), which is absent for the non-success group (one-sided t-test, P=0.970,0.901,0.967). The centers and error bars denote the mean and s.e.m.

FIG. 11J depicts the AUROC score of predicting ultimate success over all samples in accordance with an illustrative embodiment. FIG. 11K depicts the AUROC score of predicting ultimate success over samples of human-targeted attacks in accordance with an illustrative embodiment. FIG. 11L depicts the AUROC score of predicting ultimate success over samples that include vague data on fatality in accordance with an illustrative embodiment. The centers and error bars of AUROC scores denote the mean and s.e.m calculated from 10-fold cross validation over 50 randomized iterations. FIG. 11M depicts the temporal scalling pattern for a threshold of fatal attacks that killed at least 5 people in accordance with an illustrative embodiment. FIG. 11N depicts the temporal scalling pattern for a threshold of fatal attacks that killed at least 10 people in accordance with an illustrative embodiment. FIG. 11O depicts the temporal scalling pattern for a threshold of fatal attacks that killed at least 100 people in accordance with an illustrative embodiment. *: P<0.1, **: P<0.05, ***: P<0.01, NS: P≥0.1.

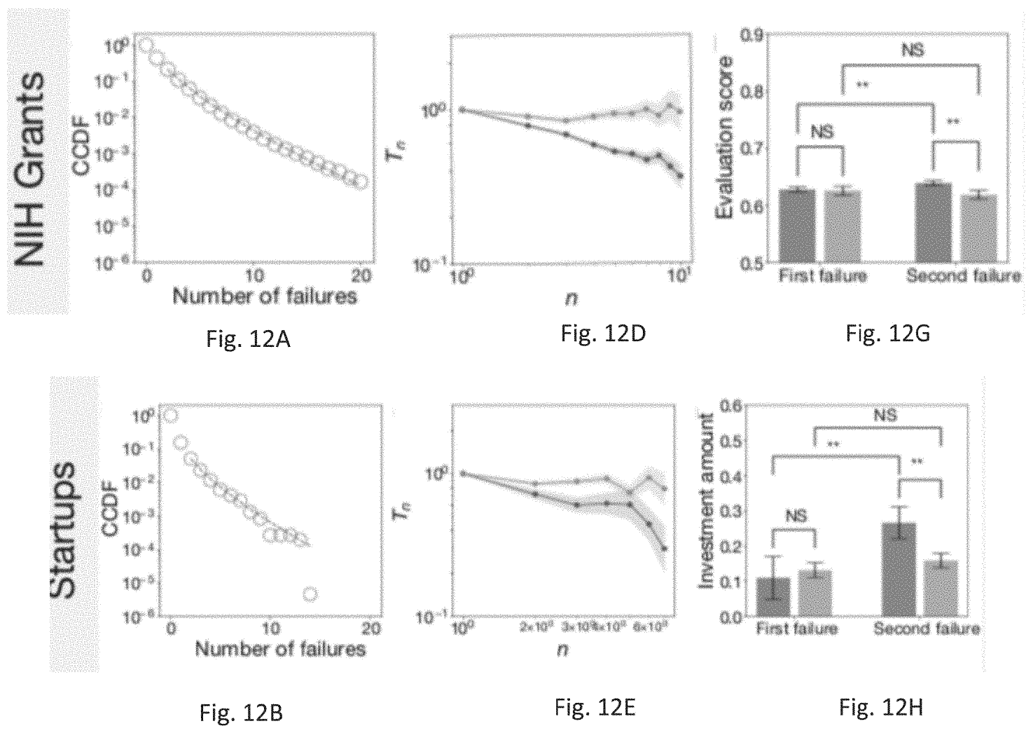

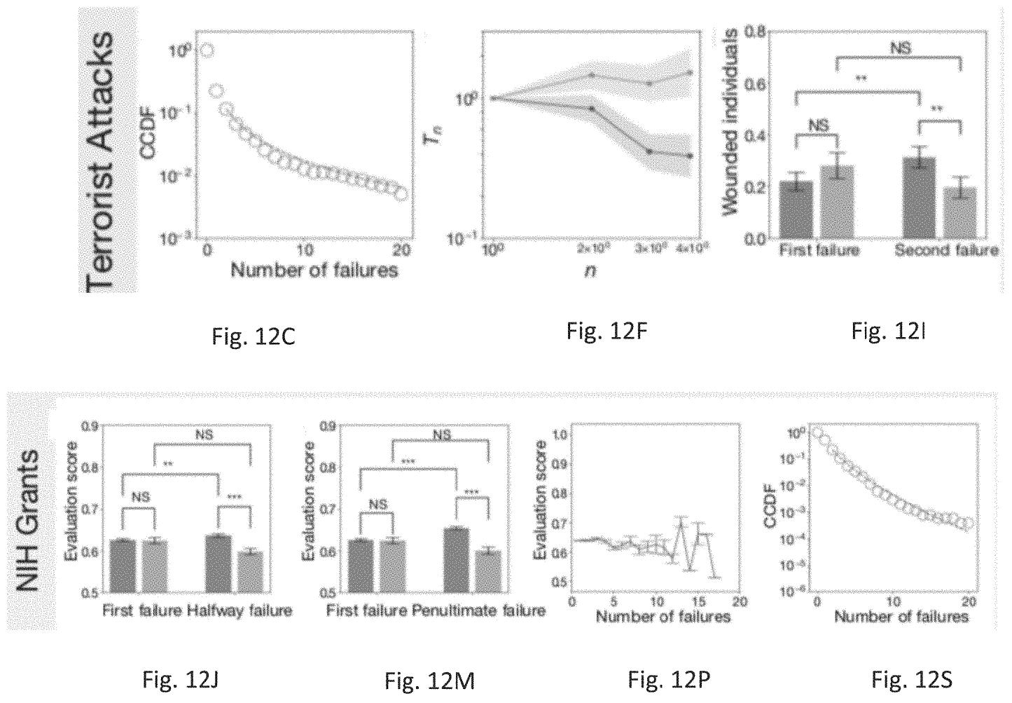

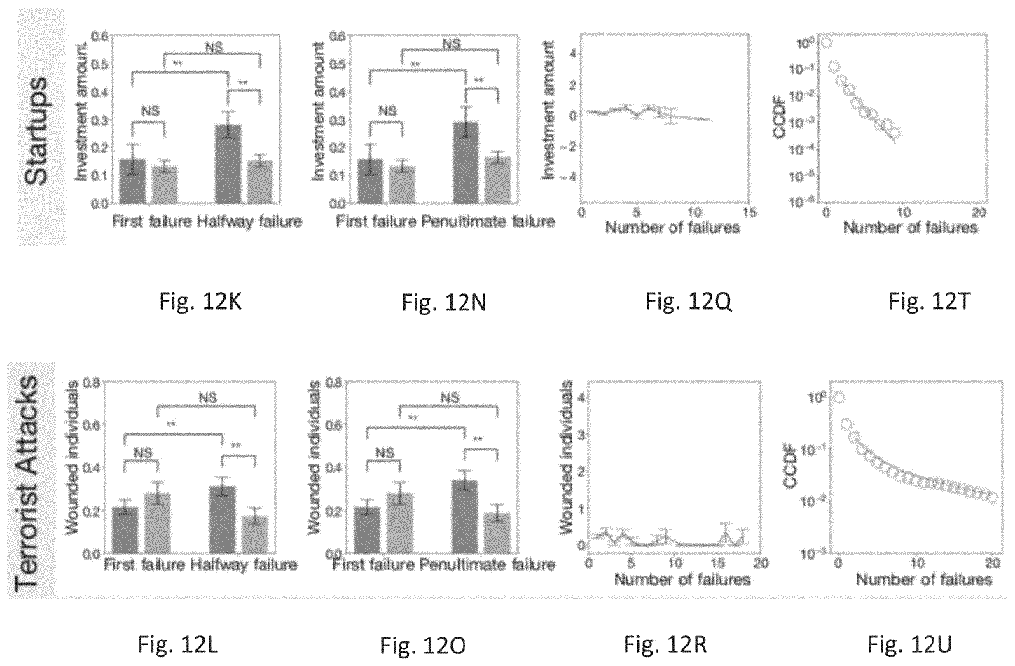

FIGS. 12A-12U illustrate additional robustness checks that were conducted. FIG. 12A depicts a failure streak for the NIH grant data, while controlling for temporal variation, in accordance with an illustrative embodiment. FIG. 12B depicts a failure streak for the startup data, while controlling for temporal variation, in accordance with an illustrative embodiment. FIG. 12C depicts a failure streak for the terror attack data, while controlling for temporal variation, in accordance with an illustrative embodiment. Circles represent real data of success group and dashed lines represent fitting of Weibull distributions. FIG. 12D depicts the temportal scaling pattern for the NIH grant data, while controlling for temporal variation, in accordance with an illustrative embodiment. FIG. 12E depicts the temportal scaling pattern for the startup data, while controlling for temporal variation, in accordance with an illustrative embodiment. FIG. 12F depicts the temportal scaling pattern for the terror attack data, while controlling for temporal variation, in accordance with an illustrative embodiment. The shaded area shows mean±s.e.m. of Tₙ (logged).

FIG. 12G depicts performance dynamics for the NIH grant data, while controlling for temporal variation, in accordance with an illustrative embodiment. FIG. 12H depicts performance dynamics for the startup data, while controlling for temporal variation, in accordance with an illustrative embodiment. FIG. 12I depicts performance dynamics for the terror attack data, while controlling for temporal variation, in accordance with an illustrative embodiment. In FIG. 12G n=628,145,571,123, in FIG. 12H n=248,1332,237,1312, and in FIG. 12I n=231,173,229,174. The success and non-success groups who experienced a large number of consecutive failures prior to the last attempt (at least 5 for D₁, 3 for D₂ and 2 for D₃) appear indistinguishable in first failures (two-sided weighted t-test, P=0.814,0.728,0.330) but quickly diverge in second failures (two-sided weighted t-test, P=1.80×10⁻², 3.10×10⁻², 4.56×10⁻²). The success group also shows significant performance improvement (one-sided weighted t-test, P=2.10×10⁻², 1.92×10⁻², 4.53×10⁻²), which is absent for the non-success group (one-sided weighted t-test, P=0.755,0.175,0.903). The centers and error bars denote the mean and s.e.m.

FIG. 12J depicts performance dynamics based on a comparison of the first and halfway attempts for the NIH grant data in accordance with an illustrative embodiment. FIG. 12K depicts performance dynamics based on a comparison of the first and halfway attempts for the startup data in accordance with an illustrative embodiment. FIG. 12L depicts performance dynamics based on a comparison of the first and halfway attempts for the terror attack data in accordance with an illustrative embodiment. In FIG. 12J n=628,145,582,111, in FIG. 12K n=248,1332,240,1294, and in FIG. 12L n=231,173,228,175. The success and non-success groups who experienced a large number of consecutive failures prior to the last attempt (at least 5 for D₁, 3 for D₂ and 2 for D₃) appear indistinguishable in first failures (two-sided t-test, P=0.898,0.671,0.289) but quickly diverge in halfway failures (two-sided t-test, P=2.18×10⁻⁵, 1.34×10⁻², 1.34×10⁻²). The success group also shows significant performance improvement (one-sided t-test, P=2.35×10⁻², 4.54×10⁻², 3.69×10⁻²), which is absent for the non-success group (one-sided t-test, P=0.992,0.252,0.955). The centers and error bars denote the mean and s.e.m.

FIG. 12M depicts performance dynamics based on a comparison of the first and penultimate attempts for the NIH grant data in accordance with an illustrative embodiment. FIG. 12N depicts performance dynamics based on a comparison of the first and penultimate attempts for the startup data in accordance with an illustrative embodiment. FIG. 12O depicts performance dynamics based on a comparison of the first and penultimate attempts for the terror attack data in accordance with an illustrative embodiment. In FIG. 12M n=628,145,896,87, in FIG. 12N n=248,1332,227,1199, and in FIG. 12O n=231,173,230,173. The success and non-success groups who experienced a large number of consecutive failures prior to the last attempt (at least 5 for D₁, 3 for D₂ and 2 for D₃) appear indistinguishable in first failures (two-sided t-test, P=0.898,0.671,0.289) but quickly diverge in penultimate failures (two-sided t-test, P=8.50×10⁻⁸, 3.12×10⁻², 1.13×10⁻²). The success group also shows significant performance improvement (one-sided t-test, P=5.79×10⁻⁹, 4.30×10⁻², 1.33×10⁻²), which is absent for the non-success group (one-sided t-test, P=0.980,0.138,0.923). The centers and error bars denote the mean and s.e.m.

FIG. 12P depicts the correlation between length of failure streak and initial performance for samples with repeated failures in the NIH grant data in accordance with an illustrative embodiment. FIG. 12Q depicts the correlation between length of failure streak and initial performance for samples with repeated failures in the startup data in accordance with an illustrative embodiment. FIG. 12R depicts the correlation between length of failure streak and initial performance for samples with repeated failures in the terror attack data in accordance with an illustrative embodiment. In FIG. 12P n=12171, in FIG. 12Q n=2086, and in FIG. 12R n=44). As shown, correlation is weak across all three datasets (Pearson correlation r=−0.051, −0.011, −0.107 respectively).

FIG. 12S depicts a length of failure streak that still follows fat-tailed distributions conditional on the bottom 10% of initial performance samples in the NIH grant data in accordance with an illustrative embodiment. FIG. 12T depicts a length of failure streak that still follows fat-tailed distributions conditional on the bottom 10% of initial performance samples in the startup data in accordance with an illustrative embodiment. FIG. 12U depicts a length of failure streak that still follows fat-tailed distributions conditional on the bottom 10% of initial performance samples in the terror attack data in accordance with an illustrative embodiment. In FIG. 12S n=6339, in FIG. 12T n=2438, and in FIG. 12U n=1092. The two-sided KS test between sample and exponential distribution rejects the two distributions to be identical with P<0.01. *: P<0.1, **: P<0.05, ***: P<0.01, NS: P≥0.1.

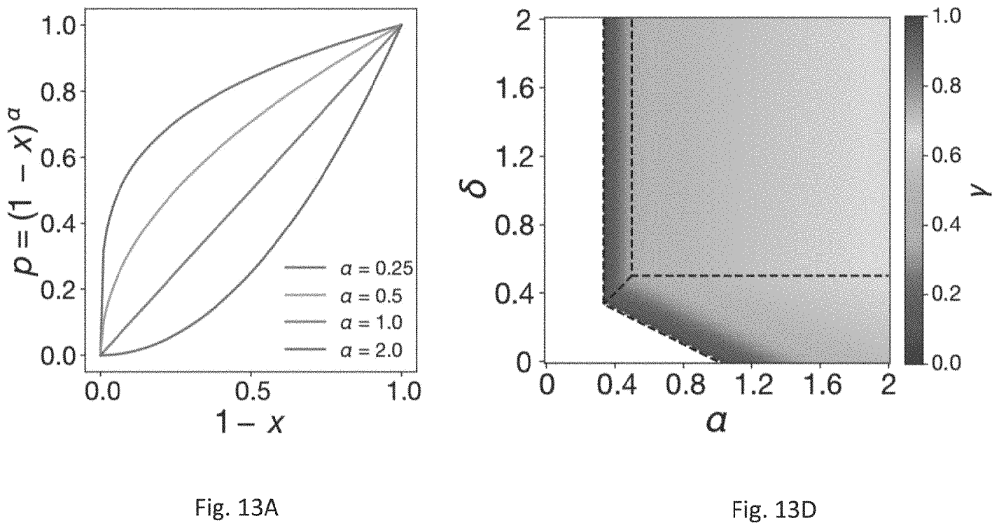

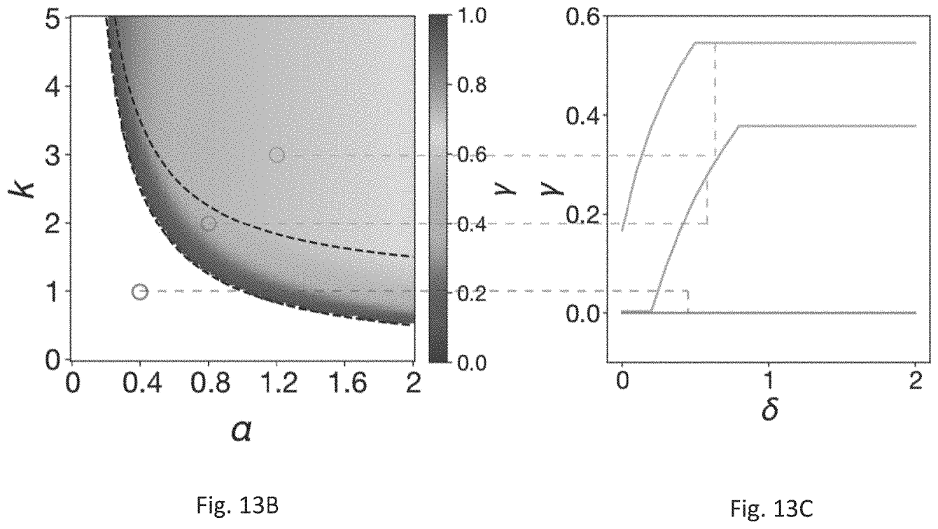

FIGS. 13A-13D depict generalization of the k model. FIG. 13A depicts how the α parameter connects the potential to improve 1−x and likelihood to create new versions p through p=(1−x)^{α} in accordance with an illustrative embodiment. FIG. 13B depicts a phase diagram of the k−α model in accordance with an illustrative embodiment. The two-dimensional parameter space is separated into three regimes, with boundaries at kα=1 and (k−1)α=1. FIG. 13C depicts the impact of δ parameter on scaling exponent γ for given of k=1,2,3 and α=0.4, 0.8, 1.2 in accordance with an illustrative embodiment. It was found that δ affects the temporal scaling parameter when it is small, but has no further impact beyond a certain point δ*=min(α, 1/k). FIG. 13D depicts a phase diagram of the k−α−δ model for k=3, with boundaries at α=δ, (k−1)δ=1, (k−1)δ+α=1, kα=1, and (k−1)α=1, respectively, in accordance with an illustrative embodiment.

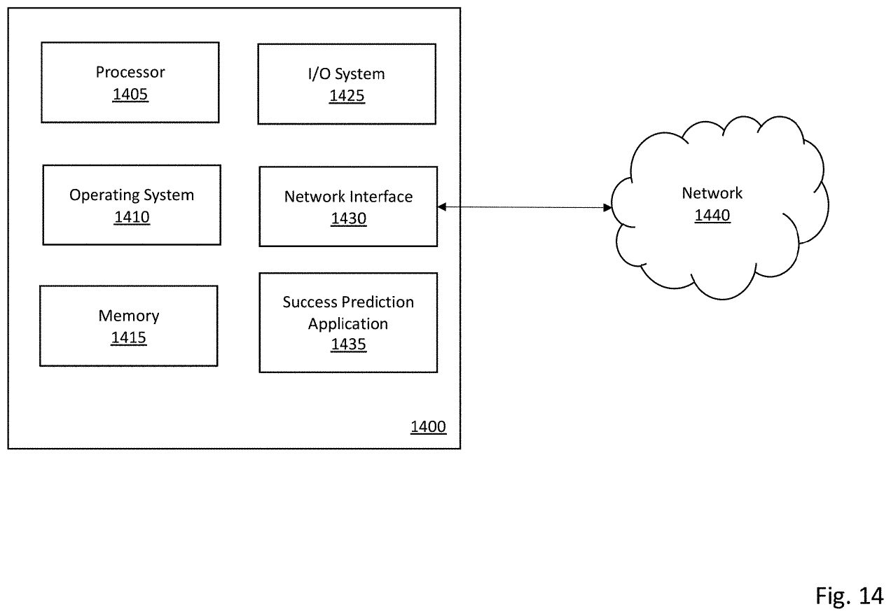

FIG. 14 is a block diagram of a computing system 1400 for a success prediction system in accordance with an illustrative embodiment. The computing system 1400 includes a processor 1405, an operating system 1410, a memory 1415, an I/O system 1425, a network interface 1430, and a success prediction application 1435. In alternative embodiments, the computing system 1400 may include fewer, additional, and/or different components. The components of the computing system 1400 communicate with one another via one or more buses or any other interconnect system. In an illustrative embodiment, the computing system 1400 can be part of a laptop computer, desktop computer, display, etc.

The processor 1405 can be any type of computer processor known in the art, and can include a plurality of processors and/or a plurality of processing cores. The processor 1405 can include a controller, a microcontroller, an audio processor, a graphics processing unit, a hardware accelerator, a digital signal processor, etc. Additionally, the processor 1405 may be implemented as a complex instruction set computer processor, a reduced instruction set computer processor, an x86 instruction set computer processor, etc. The processor 1405 is used to run the operating system 1410, which can be any type of operating system.

The operating system 1410 is stored in the memory 1415, which is also used to store programs, network and communications data, peripheral component data, algorithms, the success prediction application 1435, and other operating instructions. The memory 1415 can be one or more memory systems that include various types of computer memory such as flash memory, random access memory (RAM), dynamic (RAM), static (RAM), a universal serial bus (USB) drive, an optical disk drive, a tape drive, an internal storage device, a non-volatile storage device, a hard disk drive (HDD), a volatile storage device, etc.

The I/O system 1425 is the framework which enables users and peripheral devices to interact with the computing system 1400. The I/O system 1425 can include a mouse, a keyboard, one or more displays, a speaker, a microphone, etc. that allow the user to interact with and control the computing system 1400. The I/O system 1425 also includes circuitry and a bus structure to interface with peripheral computing devices such as power sources, USB devices, peripheral component interconnect express (PCIe) devices, serial advanced technology attachment (SATA) devices, high definition multimedia interface (HDMI) devices, proprietary connection devices, etc. In an illustrative embodiment, the I/O system 1425 is configured to receive inputs and operating instructions from a user.

The network interface 1430 includes transceiver circuitry that allows the computing system to transmit and receive data to/from other devices such as remote computing systems, servers, websites, etc. The network interface 1430 enables communication through the network 1440, which can be in the form of one or more communication networks and devices. For example, the network 1440 can include a cable network, a fiber network, a cellular network, a wi-fi network, a landline telephone network, a microwave network, a satellite network, etc. and any devices/programs accessible through such networks. The network interface 1430 also includes circuitry to allow device-to-device communication such as Bluetooth® communication.

The success prediction application 1435 includes hardware and/or software, and is configured to perform any of the operations described herein. Software of the success prediction application 1435 can be stored in the memory 1415. As an example, the success prediction application 1435 can include computer-readable instructions to analyze data sets, analyze past failures, run models to determine a likelihood of success based on past failures, etc.

As discussed above, in an illustrative embodiment, any of the apparatuses or systems described herein can include and/or be in communication with a computing system that includes, a memory, processor, user interface, transceiver, and any other computing components. Any of the operations described herein may be performed by the computing system. The operations can be stored as computer-readable instructions on a computer-readable medium such as the computer memory. Upon execution by the processor, the computer-readable instructions are executed as described herein.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A system to predict success comprising:
a memory configured to store failure data, wherein the failure data includes information regarding one or more failed attempts to achieve a goal; and
a processor operatively coupled to the memory, wherein the processor is configured to:
analyze the failure data; and
determine, with an algorithm, a likelihood of success that the goal will be achieved on a subsequent attempt, wherein the likelihood of success is based at least in part on the analysis of the failure data.

2. The system of claim 1, wherein the algorithm comprises a k-model, wherein k represents an approximate memory of an individual or entity with respect to the one or more failed attempts.

3. The system of claim 1, wherein the processor if further configured to identify one or more components from each of the one or more failed attempts.

4. The system of claim 3, wherein the processor is configured to assign an evaluation score to each of the one or more components.

5. The system of claim 4, wherein the likelihood of success is based at least in part on the evaluation score of each of the one or more components.

6. The system of claim 1, wherein the one or more failed attempts to achieve the goal include a second failed attempt and a penultimate failed attempt.

7. The system of claim 1, wherein the likelihood of success is based at least in part on a number of the failed attempts.

8. The system of claim 1, wherein the processor is configured to categorize the one or more failed attempts as stagnant attempts or progressive attempts.

9. The system of claim 1, wherein the algorithm comprises a k-a model.

10. The system of claim 9, wherein a quantifies a probably that an individual or entity will alter a subsequent attempt with one or more new components relative to the one or more failed attempts.

11. The system of claim 1, wherein the algorithm comprises a k−α−δ model.

12. The system of claim 11, wherein δ quantifies an ability of an individual or entity to recognize quality of the one or more failed attempts.

13. A method for predicting success, comprising:
storing, on a memory of a computing system, failure data, wherein the failure data includes information regarding one or more failed attempts to achieve a goal; and
analyzing, by a processor operatively coupled to the memory, the failure data; and
determining, by the processor and with an algorithm, a likelihood of success that the goal will be achieved on a subsequent attempt, wherein the likelihood of success is based at least in part on the analyzing of the failure data.

14. The method of claim 13, wherein the algorithm comprises a k-model, and further comprising determining, by the processor, an approximate memory of an individual or entity with respect to the one or more failed attempts.

15. The method of claim 13, further comprising identifying, by the processor, one or more components from each of the one or more failed attempts.

16. The method of claim 15, further comprising assigning, by the processor, an evaluation score to each of the one or more components, wherein the likelihood of success is based at least in part on the evaluation score of each of the one or more components.

17. The method of claim 13, wherein the one or more failed attempts to achieve the goal include a second failed attempt and a penultimate failed attempt.

18. The method of claim 13, further comprising determining, by the processor, a number of the failed attempts, wherein the likelihood of success is based at least in part on the number of the failed attempts.

19. The method of claim 13, further comprising categorizing, by the processor, the one or more failed attempts as stagnant attempts or progressive attempts.

20. The method of claim 13, wherein the algorithm comprises a k−α model, and wherein α quantifies a probably that an individual or entity will alter a subsequent attempt with one or more new components relative to the one or more failed attempts.
